(19) United States
(12) Patent Application Publication
(10) Pub. No.: US 2024/0365110 A1
(43) Pub. Date: Oct. 31, 2024

(54) WIRELESS SENSING METHOD AND APPARATUS, DEVICE, AND STORAGE MEDIUM

(71) Applicant: VIVO MOBILE COMMUNICATION CO., LTD., Dongguan (CN)

(72) Inventors: Shengli DING, Dongguan (CN); Yannan YUAN, Dongguan (CN); Dajie JIANG, Dongguan (CN); Jian YAO, Dongguan (CN); Jianzhi LI, Dongguan (CN)

(73) Assignee: VIVO MOBILE COMMUNICATION CO., LTD., Dongguan (CN)

(21) Appl. No.: 18/765,399

(22) Filed: Jul. 8, 2024

Related U.S. Application Data
(63) Continuation of application No. PCT/CN2023/071090, filed on Jan. 6, 2023.

(30) Foreign Application Priority Data
Jan. 7, 2022 (CN) 202210016539.0

(51) Int. Cl. H04W 8/24

(52) U.S. Cl. CPC H04W 8/24

(57) ABSTRACT

A wireless sensing method and apparatus, a device, and a non-transitory computer-readable storage medium are provided. The wireless sensing method includes: determining, by a first device, wireless sensing capability information. The wireless sensing capability information is an information set used to represent whether a sensing service is able to be performed or a performance level that is able to be achieved around the sensing service when the sensing service is able to be performed.

### CROSS-REFERENCE TO RELATED APPLICATIONS

This application is a continuation of International Application No. PCT/CN2023/071090, filed on Jan. 6, 2023, which claims priority to Chinese Patent Application No. 202210016539.0, filed on Jan. 7, 2022. The entire contents of each of the above-referenced applications are expressly incorporated herein by reference.

### TECHNICAL FIELD

The present disclosure pertains to the field of communication technologies, and in particular, to a wireless sensing method and apparatus, a device, and a storage medium.

### BACKGROUND

The method for obtaining a device capability in the related technology mainly involves obtaining of communication-related capabilities. In an application of integrated sensing and communication, there are massive devices with different sensing capabilities, including a base station, user equipment (UE), an Internet of Things terminal, and the like. Sensing capabilities of various types of devices vary widely. In addition, in the application of integrated sensing and communication, there may be a compromise in device capabilities between communication services and sensing services, and between different types of sensing services. This further expands changing characteristics of the device capabilities. At present, a definition and usage for a wireless sensing capability of a device in the application of integrated sensing and communication are not clear.

### SUMMARY

Embodiments of the present disclosure provide a wireless sensing method and apparatus, a device, and a storage medium.

According to a first aspect, a wireless sensing method is provided, where the method is applied to a first device and includes:
determining, by a first device, wireless sensing capability information, where the wireless sensing capability information is an information set used to represent whether a sensing service is able to be performed or a performance level that is able to be achieved around the sensing service in a case that the sensing service is able to be performed.

According to a second aspect, a wireless sensing is provided, where the method is applied to a first sensing function network element and includes:
determining, by a first sensing function network element based on wireless sensing capability information and sensing demand information, a target device to perform a first sensing service,
where the wireless sensing capability information is from one or more devices scheduled by a first
sensing function network element; and the sensing demand information includes description of capability information required to perform the first sensing service.

According to a third aspect, a wireless sensing apparatus is provided, and includes: a first determining unit, configured to determine wireless sensing capability information, where the wireless sensing capability information is an information set used to represent whether a specific sensing service is able to be performed or a performance level that is able to be achieved around the specific sensing service in a case that the sensing service is able to be performed.

According to a fourth aspect, a wireless sensing apparatus is provided, and includes: a second determining unit, configured to determine, based on wireless sensing capability information and sensing demand information, a target device to perform a first sensing service, where
the wireless sensing capability information is from one or more devices scheduled by a first sensing function network element; and
the sensing demand information includes description of capability information required to perform the first sensing service.

According to a fifth aspect, a wireless sensing device is provided. The wireless sensing device includes a processor and a memory, the memory stores a program or an instruction that can be run on the processor, and the program or the instruction is executed by the processor to implement the steps of the method according to the first aspect or the second aspect.

According to a sixth aspect, a wireless sensing device is provided, including a processor and a communication interface, where the processor is configured to determine wireless sensing capability information, the wireless sensing capability information is an information set used to represent whether a sensing service is able to be performed or a performance level that is able to be achieved around the sensing service in a case that the sensing service is able to be performed. In some alternative embodiments, the processor is configured to determine, based on wireless sensing capability information and sensing demand information, a target device to perform a first sensing service, where the wireless sensing capability information is from one or more devices scheduled by a first sensing function network element; and the sensing demand information includes description of capability information required to perform the first sensing service.

According to a seventh aspect, a wireless sensing system is provided, and includes: a first device and a first sensing function network element, where the first device can be used to perform the steps of the wireless sensing method according to the first aspect, and the first sensing function network element can be used to perform the steps of the wireless sensing method according to the second aspect.

According to an eighth aspect, a readable storage medium is provided, where the readable storage medium stores a program or an instruction, and when the program or the instruction is executed by a processor, the steps of the method according to the first aspect or the steps of the method according to the second aspect are implemented.

According to a ninth aspect, a chip is provided. The chip includes a processor and a communication interface, the communication interface is coupled to the processor, and the processor is configured to run a program or an instruction to implement the method according to the first aspect or the second aspect.

According to a tenth aspect, a computer program/program product is provided, where the computer program/program product is stored in a storage medium, and the computer program/program product is executed by at least one processor to implement the steps of the wireless sensing method according to the first aspect or the second aspect.

In the embodiments of the present disclosure, a definition of the wireless sensing capability information is given, and the first device determines the wireless sensing capability information, which can be applied to a scenario for integrated sensing and communication.

### BRIEF DESCRIPTION OF THE DRAWINGS

FIG. 1 is a schematic diagram of a wireless communication system to which embodiments of the present disclosure can be applied;

FIG. 2 is a schematic diagram of a terminal capability reporting process in NR;

FIG. 3 is a first schematic flowchart of a wireless sensing method according to an embodiment of the present disclosure;

FIG. 4 is a first schematic interaction diagram of a wireless sensing method according to an embodiment of the present disclosure;

FIG. 5 is a second schematic interaction diagram of a wireless sensing method according to an embodiment of the present disclosure;

FIG. 6 is a third schematic interaction diagram of a wireless sensing method according to an embodiment of the present disclosure;

FIG. 7 is a fourth schematic interaction diagram of a wireless sensing method according to an embodiment of the present disclosure;

FIG. 8 is a first schematic diagram of a communication connection relationship between a sensing function network element and a first device, a second device according to an embodiment of the present disclosure;

FIG. 9 is a second schematic diagram of a communication connection relationship between a sensing function network element and a first device, a second device according to an embodiment of the present disclosure;

FIG. 10 is a second schematic flowchart of a wireless sensing method according to an embodiment of the present disclosure;

FIG. 11 is a first schematic diagram of a structure of a wireless sensing apparatus according to an embodiment of the present disclosure;

FIG. 12 is a second schematic diagram of a structure of a wireless sensing apparatus according to an embodiment of the present disclosure;

FIG. 13 is a schematic diagram of a structure of a wireless sensing device according to an embodiment of the present disclosure;

FIG. 14 is a schematic diagram of a hardware structure of a first device according to an embodiment of the present disclosure; and

FIG. 15 is a schematic diagram of a hardware structure of a sensing function network element according to an embodiment of the present disclosure.

### DETAILED DESCRIPTION

The following clearly describes the technical solutions in the embodiments of the present disclosure with reference to the accompanying drawings in the embodiments of the present disclosure. Apparently, the described embodiments are some but not all of the embodiments of the present disclosure. All other embodiments obtained by a person of ordinary skill in the art based on the embodiments of the present disclosure shall fall within the protection scope of the present disclosure.

The terms “first”, “second”, and the like in the specification and claims of the present disclosure are used to distinguish between similar objects instead of describing a specific order or sequence. It should be understood that, the terms used in such a way are interchangeable in proper circumstances, so that the embodiments of the present disclosure can be implemented in an order other than the order illustrated or described herein. Objects classified by “first” and “second” are usually of a same type, and the number of objects is not limited. For example, there may be one or more first objects. In addition, in the specification and the claims, “and/or” represents at least one of connected objects, and the character “/” generally represents an “or” relationship between associated objects.

It should be noted that technologies described in the embodiments of the present disclosure are not limited to a Long Time Evolution (LTE)/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), single-carrier frequency division multiple access (SC-FDMA), and other systems. The terms “system” and “network” in the embodiments of the present disclosure may be used interchangeably. The described technologies can be applied to both the systems and the radio technologies mentioned above as well as to other systems and radio technologies. The following descriptions describe a new radio (NR) system for example purposes, and NR terms are used in most of the following descriptions, but these technologies can also be applied to an application other than an NR system application, for example, a 6^{th} generation (6G) communication system.

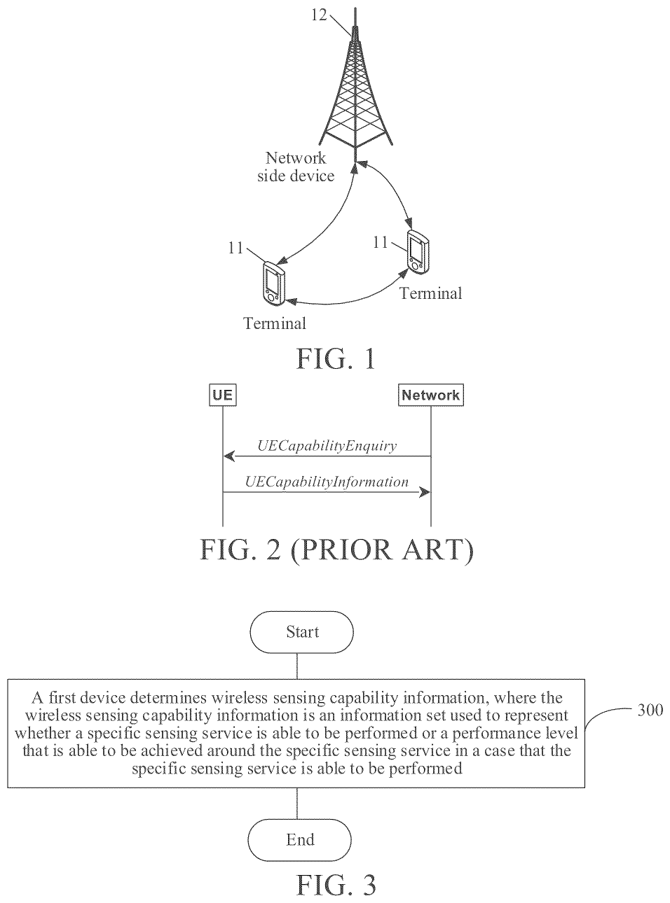

FIG. 1 is a block diagram of a wireless communication system to which embodiments of the present disclosure can be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile Internet device (MID), an augmented reality (AR)/virtual reality (VR) device, a robot, a wearable device, vehicle user equipment (VUE), pedestrian user equipment (PUE), smart household (household devices with wireless communication functions, such as a refrigerator, a television, a washing machine, or furniture), a game console, a personal computer (PC), a teller machine, or a self-service machine, and the wearable device includes a smart watch, a smart band, smart earphones, smart glasses, smart jewelry (a smart bracelet, a smart hand chain, a smart ring, a smart necklace, a smart bangle, a smart anklet, or the like), a smart wristband, smart clothes, and the like. It should be noted that, a specific type of the terminal 11 is not limited in the embodiments of the present disclosure. The network side device 12 may include an access network device or a core network device. The access network device 12 may also be referred to as a radio access network device, a radio access network (RAN), a radio access network function, or a radio access network unit. The access network device 12 may include a base station, a WLAN access node, a Wi-Fi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission reception point (TRP), or another appropriate term in the art. As long as a same technical effect is achieved, the base station is not limited to a specified technical term. It should be noted that, in the embodiments of the present disclosure, only a base station in an NR system is used as an example, but a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), unified data repository (UDR), a home subscriber server (HSS), a centralized network configuration (CNC), a network repository function (NRF), a network exposure function (NEF), a local NEF (L-NEF), a binding support function (BSF), and an application function (AF). It should be noted that, in the embodiments of the present disclosure, the core network device in the NR system is merely used as an example for description, but a specific type of the core network device is not limited.

The following first describes related content involved in the embodiments of the present disclosure.

### (1) Integrated Sensing and Communication/Integrated Sensing-Communication

The beyond fifth generation (B5G) and 6G wireless communication systems are expected to provide various high-precision sensing services, such as indoor positioning of robot navigation, Wi-Fi sensing of smart household and radar sensing of autonomous vehicles. Sensing and communication systems are usually designed separately and occupy different bands. Then, due to the widespread deployment of millimeter wave and large-scale multi-input multi-output (MIMO) technology, communication signals in future wireless communication systems usually have high resolution in both time domain and angle domain, so that it is possible to realize high-precision sensing by using communication signals. Therefore, it is better to jointly design the sensing and communication systems to share the same band and hardware, to improve frequency efficiency and reduce hardware costs. This prompts the research on integrated sensing and communication (Integrated Sensing and Communication, ISAC). ISAC will become a key technology in the future wireless communication system to support many important application scenarios. For example, in a future autonomous vehicle network, the autonomous vehicle will get a lot of information from the network, including ultra-high resolution maps and near-real-time information, to navigate and avoid upcoming traffic congestion. In the same case, a radar sensor in the autonomous vehicle should be able to provide a powerful and high-resolution obstacle detection function, and the resolution is in the order of centimeters. The ISAC technology for autonomous vehicles provides the possibility of high data rate communication and high-resolution obstacle detection by using the same hardware and spectrum resources. Other applications of ISAC include indoor location and activity recognition based on Wi-Fi, communication and sensing of unmanned aircraft, XR, integration of radar and communication, and the like. Each application has different requirements, restrictions, and regulatory issues. ISAC has attracted great research interest and attention from academia and industry. For example, there are more and more academic publications about ISAC recently, from transceiver architecture design, ISAC waveform design, joint coding design, time-frequency-space signal processing, to experimental performance delay, prototype design and field test.

ISAC achieves low-cost integration of communication and sensing functions by sharing hardware devices and defining functions by software, and main features thereof are as follows: first, the architecture is unified and simplified; second, the functions are reconfigurable and extensible; and third, the efficiency is improved and the costs are reduced. Advantages of the integrated sensing and communication mainly include three aspects: first, costs and a size of the device are reduced; and second, a spectrum utilization rate is improved; and third, system performance is improved.

Academics usually divide the development of ISAC into four stages: co-existence, co-operation, co-design, and collaboration.

Co-existence: communication and sensing are two separate systems, which may interfere with each other. Main methods to solve the interference are: distance isolation, band isolation, time division operation, MIMO technology, precoding, and the like.

Co-operation: communication and sensing share the same hardware platform, and use common information to improve common performance. Power distribution between communication and sensing has great impact on the system performance. The main problems are: low signal-to-noise ratio, mutual interference, and low throughput.

Co-design: communication and sensing become a fully joint system, including joint signal design, waveform design, coding design, and the like. In the early stage, there are a linear frequency modulated waveform, a spread spectrum waveform, and the like, and later it focuses on orthogonal frequency division multiplexing (OFDM) waveforms and MIMO technology.

Collaboration: a plurality of nodes for integrated sensing and communication cooperate with each other to achieve a common goal. For example, radar detection information is shared through communication data transmission. Typical scenarios include a driver assistance system, radar-assisted communication, and the like.

At present, typical scenarios for integrated sensing and communication that is expected to be realized due to the technology upgrading of the architecture of the 5G communication system are shown in Table 1 below.

TABLE 1
Typical scenarios for integrated sensing and communication

| Wireless sensing | | |
|---|---|---|
| categories | Sensing functions | Application scenarios |
| Large-scale | Weather, air quality, and | Atmosphere, agriculture, |
| macro sensing | the like | life services |
| category | Vehicle flow | Smart city, intelligent |
| | (intersection) and | transportation, and business |
| | pedestrian flow (subway | services |
| | entrance) | |
| | Animal movement, | Animal husbandry, |
| | migration, and the like | ecological environmental |
| | | protection, and the like |
| | Target tracking, ranging, | Many application scenarios |
| | speed measurement, | of conventional radar |
| | outline, and the like | |
| | Three-dimensional map | Intelligent driving, |
| | construction | navigation, and smart city |
| Close-range | Action posture | Smart interaction of smart |
| refined sensing | recognition | phones, games, and smart |
| category | | household |
| | Heartbeat, breathing, and | Health and medical care |
| | the like | |
| | Imaging, material | Security inspection, |
| | detection, and the like | industry, and the like |

### (2) UE Capability in NR

The NR system relies on accurate and efficient coordination between the base station and the UE, where the UE capability is an important part of coordination between the base station and the UE. The base station can schedule the UE correctly only after the UE capability is learned of. If the UE supports a function, the base station can configure the function for the UE; or if the UE does not support a function, the base station cannot configure the function for the UE.

The UE capability mainly includes two parts: a network capability and an air interface capability.

### Network Capability:

after being attached to the network, the UE actively reports the network capability thereof to the core network through NAS signaling.

### Air Interface Capability:

according to TS38.331, there are two main processes for a network side to query the air interface capability of the UE: UE capability requesting and UE capability reporting. When the UE needs to report the UE capability to the base station, the base station may deliver a UECapabilityEnquiry command to the UE. When the UE receives the UECapabilityEnquiry command, the UE reports the UE capability UECapabilityInformation based on the command. FIG. 2 is a schematic diagram of a terminal capability reporting process in NR.

A UE feature corresponding to the UE air interface in NR mainly includes: three main categories: L1, L2, and L3, radio frequency (RF)), and radio resource management (RRM).

In addition, the UE capability is divided into different levels of capability.

UE capability that is specific to the UE: each UE may have different capabilities, and this UE capability is applicable to all carriers and carrier combinations supported by the UE.

UE capability at the level of Band Combination: each band combination can have different capabilities. For example, Band Combination of Band3+Band77 supports a specific UE capability, while Band1+Band78 may not support the UE capability.

UE capability at the level of Band: each band may have different capabilities. For example, Band 77 supports a specific UE capability, while Band 78 may not support the UE capability.

The following describes in detail the wireless sensing method and apparatus, a device, and a storage medium provided in the embodiments of the present disclosure through some embodiments and application scenarios thereof with reference to the accompanying drawings.

The wireless sensing method proposed in the present disclosure includes: a definition method of wireless sensing capability information and a usage of the wireless sensing capability information in an application of integrated sensing and communication, further including a method for selecting, based on the wireless sensing capability information, a device that performs a sensing service. The device herein includes: a base station, UE, a transmission reception point TRP, a reconfigurable intelligent surface (RIS), an access Point (AP), and the like.

It should be noted that, in the embodiments of the present disclosure, a sensing function network element refers to a network node in the core network and/or the wireless access network that is responsible for at least one function such as sensing request processing, sensing resource scheduling, sensing information interaction, sensing data processing, and the like, and may be an upgrade based on an AMF or a location management function (LMF) in the existing 5G network, or other existing or newly defined network nodes. All of these are referred to as the sensing function network element in the present disclosure for ease of description.

FIG. 3 is a first schematic flowchart of a wireless sensing method according to an embodiment of the present disclosure. As shown in FIG. 3, the method includes the following steps.

Step 300. A first device determines wireless sensing capability information, where the wireless sensing capability information is an information set used to represent whether a sensing service is able to be performed or a performance level that is able to be achieved around the sensing service in a case that the sensing service is able to be performed.

It can be understood that wireless sensing capability information of a device in a scenario for integrated sensing and communication may represent whether a sensing service is able to be performed or represent a performance level that is able to be achieved around the sensing service in a case that the sensing service is able to be performed.

The sensing service can be the large-scale macro sensing service as shown in Table 1, or the close-range refined sensing service. The sensing service is not specifically limited in the present disclosure.

The first device may be a base station, UE, TRP, RIS, AP and other devices that may perform the sensing service. The first device is not specifically limited in the present disclosure.

It should be noted that, the first device determines wireless sensing capability information, and the wireless sensing capability information is used for a first sensing function network element to select a device to perform the first sensing service.

In this embodiment of the present disclosure, a definition of the wireless sensing capability information is given, and the first device determines the wireless sensing capability information, which can be applied to a scenario for integrated sensing and communication.

In some embodiments, the wireless sensing capability information includes: a first capability set and/or a second capability set, where the first capability set is a sensing-enhanced capability set existing in communication; and the second capability set is a sensing-specific capability set.

The first capability set is described as follows.

The first capability set includes at least one of the following:
1) a frequency-related capability, where
the frequency-related capability includes at least one of the following:
a band or a band combination supporting a sensing function and a bandwidth of each band or band combination;
a receive/transmit capability of a sensing signal supported by each band or band combination, including at least one of the following: supporting transmission of the sensing signal; supporting reception of the sensing signal; supporting transmission and reception of the sensing signal through time division; supporting simultaneous transmission and reception of the sensing signal; and
a quantity of independent radio frequency channels or a quantity of antennas or an antenna layout for receiving/transmitting the sensing signal supported by each band or band combination.
2) a power-related capability;
the power-related capability includes at least one of the following:
a supported power level of the sensing signal, and/or a maximum peak power of the sensing signal, and/or a maximum average power of the sensing signal;
a supported maximum transmission time ratio of the sensing signal, and/or a maximum transmission power of the sensing signal for a given transmission time ratio;
whether to support power adaptive adjustment of the sensing signal, and/or a power control parameter; and
whether to support a maximum power back-off mechanism, and/or a supported maximum power back-off value, where
the power control parameter includes but is not limited to: a step of power control, for example, 1 dB; and a range of power control, for example, −50 dBm to 23 dBm.
3) a beam-related capability, where
the beam-related capability includes at least one of the following:
whether to support sensing signal transmitting beam scanning and/or receiving beam scanning;
whether to support sensing signal transmitting beam selection and/or receiving beam selection;
whether to support sensing signal transmitting beam adaptation and/or receiving beam adaptation;
whether to support sensing signal transmitting beamforming and/or receiving beamforming; and
whether to support sensing signal beam measurement and a beam report.

The second capability set is described as follows.

The second capability set includes at least one of the following:
1) a capability for sensing a radio frequency, where
the capability for sensing a radio frequency, including at least one of the following:
1a) whether to support bandwidth splicing of the sensing signal and corresponding signal processing, where
the bandwidth splicing refers to generation, transmission, reception, and processing of the sensing signal by using discontinuous bands to achieve sensing performance requirements.
1b) whether to support simultaneous transmission of multiple beams, where the multiple beams include at least one of the following: a communication beam, a sensing beam, and a communication sensing beam.
1c) a switching speed of the sensing beam; and
the switching speed of the sensing beam is classified for capability levels based on a beam switching time.
1d) whether to support frequency hopping of the sensing signal.

It should be noted that, if frequency hopping of the sensing signal is supported, the capability for sensing a radio frequency further includes whether frequency hopping between sensing signal periods or frequency hopping between sensing signal frames is supported, where
the sensing signal period refers to a time for transmitting and receiving the sensing signal once, and is a basic unit for scheduling a time dimension resource of the sensing signal; and
the sensing signal frame includes several sensing signal periods, and a quantity of sensing signal periods that are included is set according to sensing requirements.
2) a supported sensing service type;
the sensing service type includes at least one of the following:
2a) a radar detection service, including at least one of the following: radar speed measurement, radar ranging, radar angle measurement, and radar imaging;
2b) a user positioning and tracking service;
2c) a three-dimensional reconstruction service, including at least one of the following: topography reconstruction and building surface reconstruction;
2d) a weather and/or air quality detection service, including at least one of the following: rainfall detection, humidity detection, particulate matter (such as PM2.5/PM10) detection, and snowfall detection;
2e) a pedestrian and/or vehicle flow detection service;
2f) a health monitoring service, including at least one of the following: heartbeat monitoring and breathing detection;
2g) an action recognition service, including at least one of the following: gesture recognition, posture recognition, and intrusion detection; and
2h) sensing signal transmission or reception based on radio frequency identification (RFID) or backscatter.
3) a supported sensing signal waveform;
types of sensing signals include: a communication dominant signal, a sensing dominant signal, a sensing-enhanced communication dominant signal, and a signal for integrated sensing and communication;
the communication dominant signal includes: an NR signal and a Wi-Fi signal;
if the NR signal is supported as the sensing signal, further including: supporting a communication data signal as the sensing signal and supporting a reference signal/a synchronization signal (a synchronization signal and PBCH block (SSB)/a channel state information-reference signal (CSI-RS)/a demodulation reference signal (DMRS)/a phase tracking reference signal (PTRS)/a sounding reference signal (SRS)/a positioning reference signal (PRS)) as the sensing signal;
if the Wi-Fi signal is supported as the sensing signal, further including: supporting the communication data signal as the sensing signal and supporting the reference signal/the synchronization signal (a pilot sequence preamble/CSI-RS) as the sensing signal;
the sensing dominant signal includes: a frequency modulated continuous wave (FMCW) radar signal, an OFDM radar signal (including a phase coding OFDM radar signal), a linear frequency modulation (LFM) radar signal, a simple pulse train signal, a phase coding radar signal, an ultra wide band (UWB) signal, and the like, or other signal waveforms specially designed for sensing; and
the sensing-enhanced communication dominant signal refers to a communication dominant signal with an enhanced sensing function.

The signal for integrated sensing-communication (also referred to as the signal for integrated sensing and communication) includes: a reference signal designed for the sensing function, further including: a periodic reference signal, an aperiodic reference signal, and a full bandwidth reference signal.

The supported sensing signal waveform includes at least one of the following:
supporting transmission and/or reception, and/or transmission and reception through time division, and/or simultaneous transmission and reception of a communication dominant signal;
supporting transmission and/or reception, and/or transmission and reception through time division, and/or simultaneous transmission and reception of a sensing dominant signal;
supporting transmission and/or reception, and/or transmission and reception through time division, and/or simultaneous transmission and reception of a sensing-enhanced communication dominant signal; and
supporting transmission and/or reception, and/or transmission and reception through time division, and/or simultaneous transmission and reception of a signal for integrated sensing and communication.
4) a supported sensing measurement quantity, where the supported sensing measurement quantity includes at least one of the following:
4a) original channel information, where the original channel information includes at least one of the following:
a channel matrix H or compressed quantization information of the channel matrix H;
channel state information (CSI), for example, an amplitude/a sum of squares of the amplitude of a frequency domain channel response and/or a phase; and
I-channel and Q-channel signal features of the frequency domain channel response, for example, an I-channel and/or Q-channel signal amplitude/square of the amplitude.
4b) signal strength information, where the signal strength information includes at least one of the following: a reference signal received power (RSRP) and a received signal strength index (RSSI).
4c) spectrum information, where the spectrum information includes at least one of following: a channel power delay profile (PDP), a Doppler power spectrum, a power angle spectrum (PAS), pseudo-spectral information (for example, a MUSIC spectrum), a delay-Doppler two-dimensional spectrum, and a delay-Doppler-angle three-dimensional spectrum;
4d) multipath information, where the multipath information includes at least one of following: a power, a phase, a delay, and angle information of each path in a multipath channel, where
each path in a multipath channel includes at least: a first arrival path, a line of sight (LOS) path, a first-order reflection path, and a multi-order reflection path.
4e) angle information, where the angle information includes at least one of following: an angle of arrival and an angle of departure;
it should be noted that, the angle information may be UE side angle information, base station side angle information, or reflection point angle information.
4f) difference information of signals corresponding to different antennas, where the difference information of signals corresponding to different antennas includes at least one of the following: quotient or conjugate multiplication of frequency domain channel responses of a first antenna and a second antenna, an amplitude ratio or an amplitude difference between received signals of the first antenna and the second antenna, a phase difference between signals of the first antenna and the second antenna, and a delay difference between signals of the first antenna and the second antenna, where
the quotient or conjugate multiplication of the frequency domain channel responses of the first antenna and the second antenna can also be replaced by:
an amplitude or phase of the quotient or conjugate multiplication of the frequency domain channel responses of the first antenna and the second antenna; or
an I-channel or Q-channel of the quotient or conjugate multiplication of the frequency domain channel responses of the first antenna and the second antenna; or
an I-channel or Q-channel projection operation of the quotient or conjugate multiplication of the frequency domain channel responses of the first antenna and the second antenna, where
the projection operation may be I*cos (theta)+Q*sin (theta), where theta is an angle value, different values of theta correspond to different projections, I represents I-channel data, and Q represents Q-channel data.
4g) target parameter information determined based on the original channel information, where the target parameter information includes at least one of the following: Doppler spread, Doppler frequency shift, maximum delay spread, angle spread, a coherence bandwidth, and a coherence time;
4h) radar point cloud information; and
4i) a measurement quantity obtained by performing calculation based on at least two items of the original channel information, the signal strength information, the spectrum information, the multipath information, the angle information, the difference information of signals corresponding to different antennas, the target parameter information, and the radar point cloud information.

In other words, the supported sensing measurement quantity further includes a new measurement quantity generated by performing calculation based on two or more measurement quantities in 4a) to 4h) besides the measurement quantities in 4a) to 4h).
5) a supported sensing indicator;
the supported sensing indicator includes at least one of the following:
5a) a sensing coverage;
the sensing coverage is used to represent spatial coverage that a device can cover when performing a sensing service while meeting requirements, such as: range of radar detection, regional range of weather detection, and the like;
5b) a sensing resolution;
the sensing resolution is used to represent a difference between two objects, events, or attributes in a dimension when a device can distinguish between two different objects, events, or attributes in performing a sensing service, such as: a ranging resolution, an angle measurement resolution, a speed measurement resolution, and the like;
5c) sensing accuracy;
the sensing accuracy (or a sensing error) is used to represent an error law between the target, the event, or the attribute obtained by the device by performing the sensing service and a corresponding real value, which can be expressed as an absolute value, a standard deviation, or the like, for example: a ranging error, a rainfall rate measurement error in weather detection, and the like;
5d) a sensing delay-related capability, including at least one of the following: a delay from a moment for receiving the sensing demand information to a moment for sending the sensing signal;
a delay from a moment for receiving the sensing demand information to a moment for receiving the sensing signal;
a delay from a moment for receiving the sensing signal to a moment for generating a sensing measurement quantity; and
a delay from a moment for receiving the sensing signal to a moment for reporting a sensing measurement quantity, where
the sensing delay is quantized into several symbol periods or other time units, and the sensing signal delay supported by the device is described through the sensing measurement quantity or a sensing measurement quantity set, that is, the UE may report different sensing delays corresponding to measurement quantities or measurement quantity sets, where
the moment for receiving the sensing signal includes a start moment or an end moment for receiving the sensing signal; and the moment for sending the sensing signal includes a start moment or an end moment for sending the sensing signal.
5e) a sensing update rate;
the sensing update rate is described by a time interval between two times of adjacent sensing processes performing and sensing result obtaining.
5f) a detection probability;
when a target exists or an event occurs, the device performs the sensing service and correctly detects a probability of the existence of the target or the occurrence of the event; for example, a probability that a person can be detected correctly when the person invades in intrusion detection.
5g) a false alarm probability.
when a target does not exist or an event does not occur, a probability that the device performs the sensing service and erroneously reports the existence of the target or the occurrence of the event; for example, in intrusion detection, a probability that a device reports a person intrusion when there is no person intrusion.
6) a supported control or scheduling capability related to sensing, including at least one of the following:
6a) whether to support simultaneously scheduling of communication and sensing control information, including one of the following:
scheduling communication only;
scheduling sensing only; and
simultaneously scheduling communication and sensing, where
the scheduling sensing includes that the device receives the control information, and the control information is used to schedule the device to detect a downlink sensing signal or schedule the device to send an uplink sensing signal; and
the scheduling communication includes that the device receives the control information, and the control information schedules the device to receive downlink data or send uplink data.
6b) a quantity of services supported simultaneously or through time division in a time unit, including at least one of the following:
a quantity of sensing services supported simultaneously or through time division;
a quantity of sensing signal waveforms supported simultaneously or through time division;
a quantity of sensing signals detected simultaneously or through time division; and
a quantity of sensing measurement quantities supported or processed simultaneously or through time division.
6c) whether to support indicating and/or reporting at least one of a sensing service type, a sensing signal waveform, and a sensing measurement quantity by using physical layer signaling; and
6d) a physical layer buffer size for temporary storage of sensing data, where the sensing data includes at least one of the following: configuration information used for sensing and a sensing measurement quantity.
7) a capability of assistance information related to sensing, including at least one of the following:
7a) mobility of a device;
the mobility of a device refers to possible motion characteristics of the device, and the sensing service has requirements for the motion characteristics of the device that performs the service, for example, a location service usually requires the device to move at rest or low speed, while a synthetic aperture radar imaging service requires the device to have a moving speed; and devices can be classified based on mobility as follows:
a static device, for example, a base station, a TRP, a Wi-Fi router, and the like;
a low-speed device, for example, a smart household device;
a medium-speed device, for example, a mobile phone (moving with a pedestrian); and
a high-speed device, for example, in-vehicle radar.
7b) a capability and accuracy for obtaining a location, a posture, or motion information of the device.

Many examples in integrated sensing and communication need to use the location/posture/motion information of the device, and the capability and accuracy for obtaining the location/posture/motion information of the device determine a type of sensing service that the device can perform, for example, the location service requires the device to have high-precision location information, while a weather sensing service has lower requirements for device location information (for example, a location error can be in the order of tens of meters).

The following describes attributes of the wireless sensing capability information.

The attributes of the wireless sensing capability information include: a granularity of the wireless sensing capability information and time-varying characteristics of the wireless sensing capability information.

In some embodiments, a granularity of the wireless sensing capability information includes:
1) per band/band combination: indicating that the wireless sensing capability information is applicable to the per band/band combination;
for example, the capability of the per band/band combination includes: frequency, power, and beam-related capability information in the first capability set and the capability for sensing a radio frequency in the second capability set.
2) per service/service category: indicating that the wireless sensing capability information is applicable to the sensing service or the sensing service category;
for example, a capability of the per service/service category includes: a supported sensing signal waveform, a supported sensing measurement quantity, a supported sensing indicator, and a supported sensing-related control/scheduling capability in the second capability set.
3) per device: indicating that the wireless sensing capability information is applicable to the device;
for example, a capability of the per device includes: a supported sensing service type and a supported sensing-related control/scheduling capability in the second capability set.

It is worth noting that a granularity division example of the wireless sensing capability information only represents one possible granularity division method, and a granularity division method may be flexibly set according to an actual situation.

The time-varying characteristics of the wireless sensing capability information refer to that based on whether the wireless sensing capability information may change with a current service condition and other factors, the wireless sensing capability information may be divided into: static capability information and dynamic capability information.

The static capability information is information for representing an inherent capability of the device determined by a software and/or hardware configuration of the device.

The static capability information includes content from the following two aspects:
1) maximum capability information of a device, a frequency in the first capability set is used as an example, and the static capability information is a set of all bands that the device can support. The maximum capability information may only change when software and/or hardware of the device changes; and
2) capability information that may not change, such as: attribute information of the device and the like.

The dynamic capability information is information for representing an available capability of sensing service.

In other words, the dynamic capability information is capability information that remains after being occupied by a high-priority service and/or is available after being limited by a capability limiting factor.

The frequency in the first capability set is still used as an example, and the dynamic capability information is an available band that remains after being occupied by the high-priority service of the device. An upper limit of the dynamic capability information is corresponding static capability information, and may change with a running condition of the device.

The priority refers to a global service priority and a priority globally and uniformly allocated by the core network for a communication service, a sensing service, and a service for integrated sensing and communication, and priority identification information is included in a sensing demand. The high-priority service may occupy a device capability of a currently running low-priority service, and the low-priority service can use only a remaining device capability after being occupied by the high-priority service.

A typical case of the capability limiting factor is capability back-off, for example, when the device is out of power, or a temperature exceeds a threshold, or hardware is damaged, the dynamic capability of the device is changed by turning off some radio frequency modules, reducing a transmission power, or the like. In some alternative embodiments, capability recovery after the capability back-off. For example, the dynamic capability of the device may also change when the power is restored after the power is insufficient, the temperature is restored after the temperature exceeds the threshold, or the like.

It is worth noting that attribute examples of the static capability information and the dynamic capability information represent only a possible situation, and do not limit the attributes of the wireless sensing capability information.

After introducing the definition of the wireless sensing capability information, the present disclosure further provides a usage for the wireless sensing capability information.

In an implementation, a first device determines a first sensing function network element based on the wireless sensing capability information and accesses a first network, where the first network is a network corresponding to the first sensing function network element.

In other words, when the first device accesses the first network, it is required to determine, based on the wireless sensing capability information, an appropriate sensing function network element for access (or switch), so that the sensing function network element may provide a network service for the first device.

In an implementation, when a new demand for selecting a sensing device is generated, device selection needs to be performed based on the wireless sensing capability information.

The demand for selecting a sensing device includes the following options:
1) when receiving a new sensing task request, the sensing function network element needs to select a device that performs the sensing service;
2) the device (the first device) currently performing the sensing service cannot continue to perform the sensing service, and the sensing function network element performs reselection of the device that performs the sensing service, including the following options:
relative movement between a sensing target and the first device enables the sensing target to be beyond a range that the first device can cover when performing the sensing service;
a movement of the first device enables the range that the first device can cover when performing the sensing service to not include a sensing target area; and
3) due to the change of the dynamic capability information, a device which is more suitable for performing the sensing service than the first device appears.

The following describes, from a first device side, the method for selecting, based on the wireless sensing capability information, a device that performs the sensing service provided in this embodiment of the present disclosure.

In some embodiments, after the first device determines the wireless sensing capability information, the method further includes:
reporting, by the first device, the static capability information of the first device to a first sensing function network element.

In some embodiments, that the first device reports the static capability information of the first device to a first sensing function network element includes one of the following:
reporting the static capability information of the first device immediately after the first device accesses a first network;
reporting the static capability information of the first device in a case that the first device is in an idle state after accessing the first network; and
reporting the static capability information of the first device in a case that first capability enquiry information sent by the first sensing function network element is received, where the first capability enquiry information is used to instruct the first device to report the static capability information, where
the first network is a network corresponding to the first sensing function network element.

In other words, an occasion in which the first device reports the static capability information of the first device to the first sensing function network element includes the following options:
reporting immediately: the first device reports the static capability information immediately after accessing the first network. For example, UE reports the static capability information to the first sensing function network element immediately after establishing RRC connection with the first network;
reporting in an idle time: the first device does not report the static capability information immediately after accessing the first network, but reports the static capability information to the first sensing function network element in an idle time. For example, the UE reports the static capability information to the first sensing function network element when there is no data communication service or a data communication traffic is small; and
reporting as a response: the first device does not report the static capability information immediately after accessing the first network, but reports the static capability information to the first sensing function network element after receiving information that the first sensing function network element requests the first device to send the static capability information.

In some embodiments, that the first device reports the static capability information of the first device to a first sensing function network element includes one of the following:
reporting, by the first device, complete information of the static capability information of the first device to the first sensing function network element;
reporting, by the first device, level information corresponding to the static capability information of the first device to the first sensing function network element;
reporting, by the first device, partial information in the static capability information of the first device to the first sensing function network element;
reporting, by the first device, a device type and/or software version information and/or hardware version information of the first device to the first sensing function network element; and
reporting, by the first device, an identification code of the static capability information of the first device to the first sensing function network element.

It can be understood that a manner in which the first device reports the static capability information thereof to the first sensing function network element includes the following options:
1) an explicit manner: that the first device directly reports the static capability information to the first sensing function network element includes the following options:
1a) reporting complete static capability information: the first device reports complete information of the static capability information thereof to the first sensing function network element, and the first sensing function network element directly stores the complete static capability information in the first sensing function network element or other network nodes accessible to the first sensing function network element after receiving the complete static capability information;
1b) reporting static capability level information: the first device reports level information of each item in the static capability information to the first sensing function network element, instead of reporting content of the static capability information, thereby reducing a data transmission amount and occupation of communication resources;
for example, sensing measurement quantities may be divided into several levels based on the operation from simple to complex, and the first device reports a supported sensing measurement quantity level to the first sensing function network element, instead of reporting which sensing measurement quantity is supported; and
1c) reporting partial static capability information: the first device reports partial key static capability information that can significantly mark the sensing capability to the first sensing function network element. For example, the first device reports a supported sensing service type to the first sensing function network element. For example, the first device reports to the first sensing function network element that the first device can support radar detection.
2) an implicit manner: that the first device does not directly report the static capability information to the first sensing function network element includes the following options:
2a) if the first device is a standard device, the first device may report a device type (for example, UE category) thereof to the first sensing function network element, and/or the first device may report software version information and/or hardware version information thereof to the first sensing function network element; and after receiving the device type and/or the software version information and/or the hardware version information of the device, the sensing function network element adds the information to a device list corresponding to the device type and/or the software version information and/or the hardware version information, or maps static capability information of the device based on the device type and/or the software version information and/or the hardware version information and stores the static capability information.
2b) if the first device is not the standard device, the first device may report an identification code of the static capability information that is in a one-to-one correspondence with the static capability information to the first sensing function network element, and the first sensing function network element compares the identification code of the static capability information with an identification code of the static capability information stored in a database of the identification codes of static capability information after receiving the identification code of the static capability information:
if the identification code of the static capability information reported by the first device is the same as a stored identification code of the static capability information, the static capability information corresponding to the stored identification code of the static capability information is used as the static capability information of the first device; and
if the identification code of the static capability information reported by the first device does not match the stored identification code of the static capability information, the first sensing function network element requests the first device to report the static capability information again in the explicit manner.

The stored identification code of the static capability information is in a one-to-one correspondence with the static capability information, and the same identification code of the static capability information corresponds to the same static capability information; and the stored identification code of the static capability information is stored in the sensing function network element or other network nodes accessible to the sensing function network element after other devices access the network.

It should be noted that, from the perspective of the first sensing function network element, the first sensing function network element may obtain static capability information of all devices scheduled by the first sensing function network element, where all the devices scheduled by the first sensing function network element form a first set, and the first device is one device in the first set.

In some optional embodiments, the method that the first sensing function network element selects a device to perform the first sensing service includes the following manner 1 to manner 5. The following describes the steps performed by the first device with reference to the method that the first sensing function network element selects a device to perform the first sensing service.

### Manner 1:

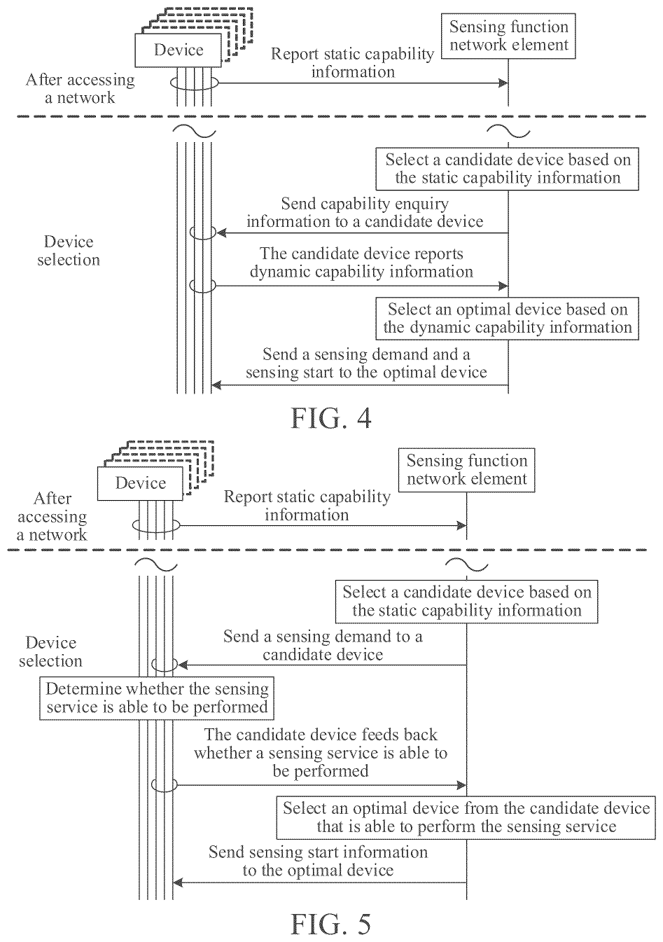

FIG. 4 is a first schematic interaction diagram of a wireless sensing method according to an embodiment of the present disclosure. As shown in FIG. 4, the first sensing function network element performs preliminary screening based on static capability information and location information of devices in the first set and with reference to sensing demand information, to determine a candidate device that possibly has a capability to perform the first sensing service, where the sensing demand information includes description of capability information required to perform the first sensing service. Candidate devices form a second set. Further, the first sensing function network element sends second capability enquiry information to the candidate devices in the second set, to instruct the candidate devices to feed back dynamic capability information. Further, the first sensing function network element determines, based on the dynamic capability information sent by the candidate device, a target device (namely, an optimal device in FIG. 4) that performs the first sensing service. In some embodiments, the first sensing function network element determines, based on the dynamic capability information sent by the candidate device with reference to location information of the candidate device and the sensing demand information, the target device to perform the first sensing service.

Therefore, in a case that the first device belongs to the second set, at a first device side, after that the first device reports the static capability information of the first device to a first sensing function network element, the method further includes:
receiving, by the first device, second capability enquiry information sent by the first sensing function network element, where the second capability enquiry information is used to instruct the first device to report the dynamic capability information; and
reporting, by the first device, the dynamic capability information of the first device to the first sensing function network element.

In some embodiments, the content indicated by the second capability enquiry information includes:
indicating reporting dynamic capability information of all entries; or
indicating reporting dynamic capability information of a designated entry.

In some embodiments, that the first device reports the dynamic capability information of the first device to the first sensing function network element includes at least one of the following:
reporting, by the first device based on indication of the second capability enquiry information, complete information of dynamic capability information of all entries or a designated entry;
reporting, by the first device based on indication of the second capability enquiry information, a part of the dynamic capability information of all entries or a designated entry that is different from the static capability information of a corresponding entry; and
reporting, by the first device based on indication of the second capability enquiry information, a part of the dynamic capability information of all entries or a designated entry that is different from historically reported dynamic capability information of a corresponding entry.

In other words, the dynamic capability information reported by the first device to the first sensing function network element may be reporting, based on indication of the second capability enquiry information, complete information of dynamic capability information of all entries or a designated entry.

In some alternative embodiments, the dynamic capability information reported by the first device to the first sensing function network element is the part different from static capability information of a corresponding entry in complete information of dynamic capability information of all entries or a designated entry and/or the part different from historically reported dynamic capability information of a corresponding entry in complete information of dynamic capability information of all entries or a designated entry.

In the manner 1, the first device reports both the static capability information and the dynamic capability information. After performing preliminary screening based on the static capability information of the device, the first sensing function network element further determines, based on the dynamic capability information of the device, the device that performs the first sensing service.

### Manner 2:

FIG. 5 is a second schematic interaction diagram of a wireless sensing method according to an embodiment of the present disclosure. As shown in FIG. 5, the first sensing function network element performs preliminary screening based on static capability information and location information of devices in the first set and with reference to sensing demand information, to determine a candidate device that possibly has a capability to perform the first sensing service, where the sensing demand information includes description of capability information required to perform the first sensing service. Candidate devices form a second set. Further, the first sensing function network element sends the sensing demand information and first request information to candidate devices in the second set, where the first request information is used to instruct the candidate devices in the second set to feed back whether the first sensing service is able to be performed. Further, the first sensing function network element determines a target device (optimal device) that performs the first sensing service from the candidate device feeding back that the first sensing service is able to be performed. In some embodiments, the first sensing function network element determines, with reference to location information of the candidate device feeding back that the first sensing service is able to be performed, a target device to perform the first sensing service from the candidate device feeding back that the first sensing service is able to be performed.

Therefore, in a case that the first device belongs to the second set, at a first device side, after that the first device reports the static capability information of the first device to a first sensing function network element, the method further includes:
receiving, by the first device, sensing demand information and first request information, where the first request information is used to instruct the first device to feed back whether a first sensing service is able to be performed;
determining, by the first device based on the sensing demand information and the dynamic capability information of the first device, whether the first sensing service is able to be performed; and
sending, by the first device, first feedback information to the first sensing function network element, where the first feedback information is used to indicate whether the first device is able to perform the first sensing service.

In other words, the first device determines whether the first sensing service is able to be performed based on the received sensing demand information and the dynamic capability information thereof, and sends the first feedback information to the first sensing function network element, where the first feedback information is used to indicate, to the first sensing function network element, whether the first device is able to perform the first sensing service.

In the manner 2, the first device reports the static capability information, and does not report the dynamic capability information. After the first sensing function network element performs preliminary screening based on the static capability information of the device, further, a device obtained through preliminary screening determines, based on dynamic capability information thereof and the sensing demand information, whether the first sensing service is able to be performed. Then the first sensing function network element determines a target device to perform the first sensing service from the device feeding back that the first sensing service is able to be performed.

### Manner 3:

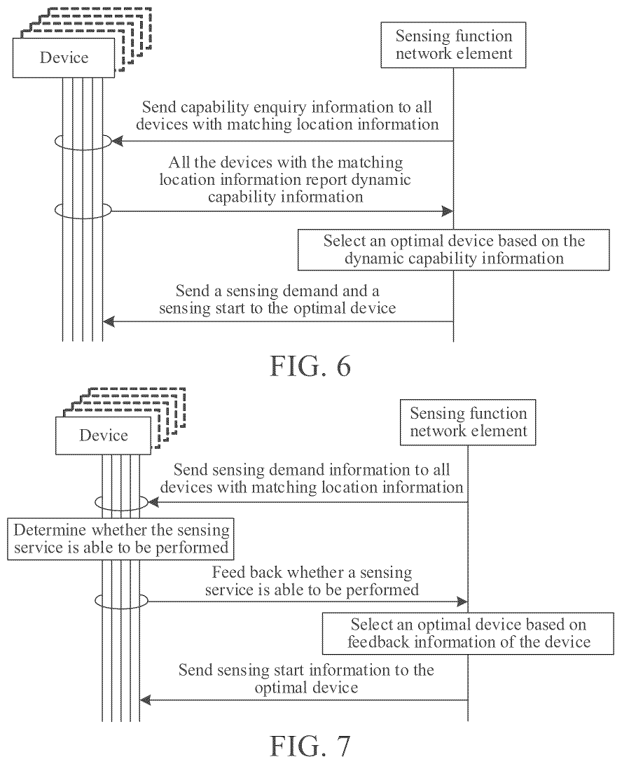

FIG. 6 is a third schematic interaction diagram of a wireless sensing method according to an embodiment of the present disclosure. As shown in FIG. 6, the first sensing function network element performs preliminary screening based on location information of devices in the first set with reference to sensing demand information, to determine a candidate device that performs the first sensing service. Candidate devices form a second set. Further, the first sensing function network element sends second capability enquiry information to the candidate devices in the second set, to instruct the candidate devices in the second set to feed back dynamic capability information. Further, the first sensing function network element determines, based on the dynamic capability information sent by the candidate devices, a target device (optimal device) that performs the first sensing service. In some embodiments, the first sensing function network element determines, based on the dynamic capability information sent by the candidate devices with reference to location information of the candidate devices and the sensing demand information, the target device to perform the first sensing service.

Therefore, in a case that the first device belongs to the second set, at a first device side, after the first device determines the wireless sensing capability information, the method further includes:
receiving, by the first device, second capability enquiry information sent by the first sensing function network element, where the second capability enquiry information is used to instruct the first device to report the dynamic capability information; and reporting, by the first device, the dynamic capability information of the first device to the first sensing function network element.

In some embodiments, the content indicated by the second capability enquiry information includes:
indicating reporting dynamic capability information of all entries; or indicating reporting dynamic capability information of a designated entry.

In some embodiments, that the first device reports the dynamic capability information of the first device to the first sensing function network element includes at least one of the following:
reporting, by the first device based on indication of the second capability enquiry information, complete information of dynamic capability information of all entries or a designated entry; and
reporting, by the first device based on indication of the second capability enquiry information, a part of the dynamic capability information of all entries or a designated entry that is different from historically reported dynamic capability information of a corresponding entry.

In the manner 3, the first device does not report the static capability information, and reports the dynamic capability information. After the first sensing function network element performs preliminary screening based on location information of all scheduled devices and the sensing demand information, further, second capability enquiry information is sent to the device obtained through preliminary screening, to obtain dynamic capability information of the device obtained through preliminary screening, and then the target device to perform the first sensing service is determined based on the dynamic capability information.

### Manner 4:

FIG. 7 is a fourth schematic interaction diagram of a wireless sensing method according to an embodiment of the present disclosure. As shown in FIG. 7, the first sensing function network element performs preliminary screening based on location information of devices in the first set with reference to sensing demand information, to determine a candidate device that performs the first sensing service. Candidate devices form a second set. Further, the first sensing function network element sends the sensing demand information and first request information to candidate devices in the second set, to instruct the candidate devices in the second set to feed back whether the first sensing service is able to be performed. Further, the first sensing function network element determines a target device (optimal device) that performs the first sensing service from the candidate device feeding back that the first sensing service is able to be performed. In some embodiments, the first sensing function network element determines, with reference to location information of the candidate device feeding back that the first sensing service is able to be performed, a target device to perform the first sensing service from the candidate device feeding back that the first sensing service is able to be performed.

Therefore, in a case that the first device belongs to the second set, at a first device side, after the first device determines the wireless sensing capability information, the method further includes:
receiving, by the first device, sensing demand information and first request information sent by the first sensing function network element, where the first request information is used to instruct the first device to feed back whether a first sensing service is able to be performed;
determining, by the first device based on the sensing demand information and the dynamic capability information of the first device, whether the first sensing service is able to be performed; and
sending, by the first device, first feedback information to the first sensing function network element, where the first feedback information is used to indicate whether the first device is able to perform the first sensing service.

In other words, the first device determines whether the first sensing service is able to be performed based on the received sensing demand information and the dynamic capability information thereof, and sends the first feedback information to the first sensing function network element, where the first feedback information is used to indicate, to the first sensing function network element, whether the first device is able to perform the first sensing service.

In the manner 4, the first device reports neither the static capability information nor the dynamic capability information. After the first sensing function network element performs preliminary screening based on location information of all scheduled devices and the sensing demand information, further, the sensing demand information and the first request information are sent to the device obtained through preliminary screening. The device obtained through preliminary screening determines, based on dynamic capability information thereof and the sensing demand information, whether the first sensing service is able to be performed. Then the first sensing function network element determines a target device to perform the first sensing service from the device feeding back that the first sensing service is able to be performed.

It should be noted that, the target device in the embodiments of the present disclosure may be one device or a combination of a plurality of devices.

In some embodiments, applicable to the manner 1 to the manner 4, the method further includes:
receiving, by the first device, first sensing start information sent by the first sensing function network element, where the first sensing start information is used to instruct the first device to perform the first sensing service.

It can be understood that in a case that the first device determines the target device to perform the first sensing service for the first sensing function network element, the first device may receive first sensing start information sent by the first sensing function network element, where the first sensing start information is used to instruct the first device to perform the first sensing service.

Particularly, in the manner 1 and the manner 3, the first device receives the sensing demand information in addition to the first sensing start information sent by the first sensing function network element.

In some embodiments, applicable to the manner 1 to the manner 4, the method further includes:
performing the first sensing service in a case that the first device receives second sensing start information sent by a second sensing function network element, and a priority of the first sensing service is higher than a priority of a second sensing service indicated by the second sensing start information; or
skipping performing the first sensing service, and reporting a device conflict message to the first sensing function network element in a case that the first device receives second sensing start information sent by a second sensing function network element, and a priority of the first sensing service is lower than or equal to a priority of a second sensing service indicated by the second sensing start information, where the device conflict message is used to instruct the first sensing function network element to reselect a device to perform the first sensing service.

It can be understood that, in a case that the first device receives the first sensing start information, if the second sensing start information sent by the second sensing function network element is also received, the following processing is required:
comparing the priority of the first sensing service with the priority of the second sensing service indicated by the second sensing start information;
if the priority of the first sensing service is higher than the priority of the second sensing service, performing the first sensing service; and
if the priority of the first sensing service is lower than or equal to the priority of the second sensing service, not performing the first sensing service, and reporting a device conflict message to the first sensing function network element, to instruct the first sensing function network element to reselect a device to perform the first sensing service.

As described above, the priority refers to a global service priority and a priority globally and uniformly allocated by the core network for a communication service, a sensing service, and a service for integrated sensing and communication, and priority identification information is included in a sensing demand.

### Manner 5:

In the application of integrated sensing and communication, many examples involve receiving/transmitting among a plurality of devices; for example, an example of bistatic radar, pedestrian flow detection/vehicle flow detection/intrusion detection based on signal attenuation between devices, breath detection or action recognition based on reflected signals, and the like. In this case, capabilities of a plurality of devices that participate in sensing are required to meet tasks respectively. For example, in a bistatic radar scenario, a transmit end device needs to have enough transmission power, while a receive end device needs to have enough angle measurement capability, and the like.

That a sensing task involves two devices is used as an example for description. This involves the sensing function network element, the first device, and the second device. The “first” and “second” only indicate the distinction between two devices without any limitation on functions or attributes of the devices.

It should be noted that, in a case of the manner 5, target devices that perform the first sensing service are the first device and the second device.

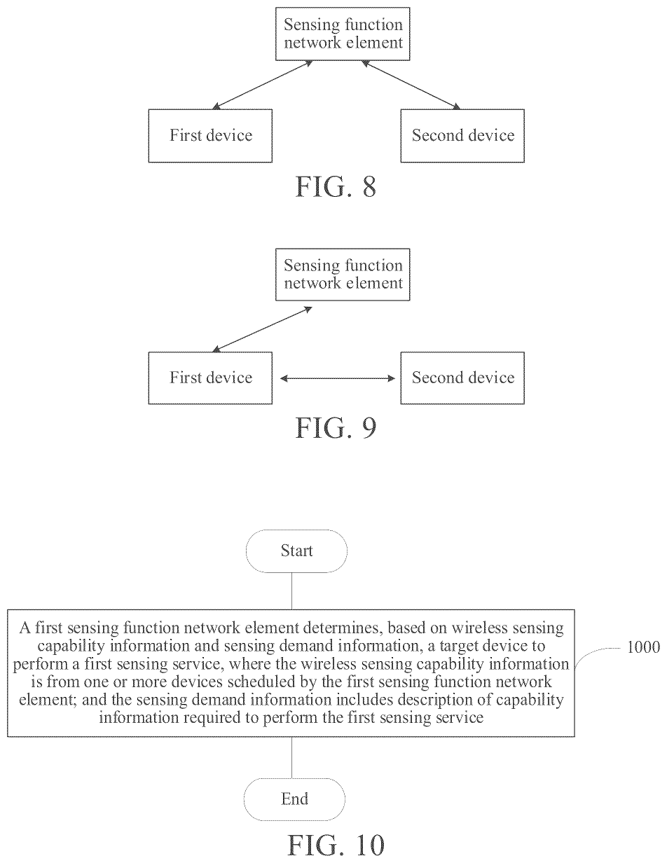

A communication connection relationship between the sensing function network element and the first device, the second device and a corresponding information interaction method are divided into the following two cases:
1) the sensing function network element communicates directly with both the first device and the second device, as shown in FIG. 8. In this case, the sensing function network element may directly interact information with the first device or the second device; and
2) the sensing function network element communicates directly with only one of the first device and the second device, and the first device communicates directly with the second device, as shown in FIG. 9. In this case, a device that communicates directly with the sensing function network element may directly interact information with the sensing function network element, and a device that cannot communicate directly with the sensing function network element requires forwarding from the device that communicates directly with the sensing function network element for interaction with the sensing function network element.

The method that the first sensing function network element selects a device for performing the first sensing service includes the following two cases.
1) The first sensing function network element selects the first device and the second device.

That the first sensing function network element selects the first device and the second device for performing the first sensing service together includes: determining, by the first sensing function network element based on requirement information for capability information of a first device in the sensing demand information, the first device, and determining, by the first sensing function network element based on requirement information for capability information of a second device in the sensing demand information, the second device that performs the first sensing service together with the first device.

When the first device and the second device are selected, on the one hand, the device capability information should be considered, on the other hand, a relative location relationship between the first device, the second device and the sensing target location and/or the sensing target area should be considered.

Interaction of device capability information between the sensing function network element and the first device, the second device may be one of the two information interaction methods in FIG. 8 and FIG. 9.

In this case, the first sensing function network element may select the first device in the method of the manner 1, the manner 2, the manner 3, or the manner 4, and the first sensing function network element may select the second device in the method of the manner 1, the manner 2, the manner 3, or the manner 4.

2) The sensing function network element selects the first device, and the first device selects the second device.

The first sensing function network element may use the method in the manner 1, the manner 2, the manner 3, or the manner 4 to determine the first device with reference to the requirement information for the capability information of the first device in the sensing demand information.

The first device may use the method in the following options to determine, with reference to the requirement information for the capability information of the second device in a sensing demand, the second device that performs the first sensing service together with the first device.

### Option 1:

the first device selects, based on static capability information of a candidate device and the requirement information for the capability information of the second device in the sensing demand information, one or more candidate second devices from the candidate device, where the candidate second device matches a sensing target location and/or a sensing target area, and the candidate device is a device scheduled by the first sensing function network element other than the first device;
the first device sends the second capability enquiry information to the candidate second device and receives dynamic capability information fed back by the candidate second device, where the second capability enquiry information is used to instruct the candidate second device to feed back the dynamic capability information; and
the first device receives the dynamic capability information fed back by the candidate second device, and determines, based on the dynamic capability information fed back by the candidate second device, the second device that performs the first sensing service together with the first device. In some embodiments, the first device determines, based on the dynamic capability information fed back by the candidate second device with reference to the requirement information for the capability information of the second device in the sensing demand information and location information of the candidate second device, the second device that performs the first sensing service together with the first device.

It should be noted that, the candidate device is a device scheduled by the first sensing function network element other than the first device. The static capability information of the candidate device is obtained by the first device from the first sensing function network element or a network node accessible to the first sensing function network element. A source of the static capability information of the first sensing function network element or at the network node accessible to the first sensing function network element is the same as that described in the manner 1.

In some embodiments, the first device may obtain, from the first sensing function network element or the network node accessible to the first sensing function network element, static capability information of the candidate device after the location information matches the sensing target location and/or the sensing target area.

### Option 2:

the first device selects, based on static capability information of a candidate device and the requirement information for the capability information of the second device in the sensing demand information, one or more candidate second devices from the candidate device, where the candidate second device matches a sensing target location and/or a sensing target area, and the candidate device is a device scheduled by the first sensing function network element other than the first device;
the first device sends the sensing demand information and the first request information to the candidate second device, and receives the first feedback information sent by the candidate second device, where the first request information is used to instruct the candidate second device to feed back whether the first sensing service is able to be performed, and the first feedback information is used to indicate whether the candidate second device is able to perform the first sensing service; and
the first device determines the second device that performs the first sensing service together with the first device from the candidate second device feeding back that the first sensing service is able to be performed. In some embodiments, the first device determines, with reference to location information of the candidate second device feeding back that the first sensing service is able to be performed, the second device that performs the first sensing service together with the first device from the candidate second device feeding back that the first sensing service is able to be performed.

It should be noted that, the candidate device is a device scheduled by the first sensing function network element other than the first device. The static capability information of the candidate device is obtained by the first device from the first sensing function network element or a network node accessible to the first sensing function network element. A source of the static capability information of the first sensing function network element or at the network node accessible to the first sensing function network element is the same as that described in the manner 1.

In some embodiments, the first device may obtain, from the first sensing function network element or the network node accessible to the first sensing function network element, static capability information of the candidate device after the location information matches the sensing target location and/or the sensing target area.

### Option 3:

the first device sends the second capability enquiry information to all candidate second devices having a first communication connection relationship with the first device and matching the sensing target location and/or the sensing target area, where the second capability enquiry information is used to instruct the candidate second device to feed back the dynamic capability information; and
the first device receives the dynamic capability information fed back by the candidate second device, and the first device determines, based on the dynamic capability information fed back by the candidate second device and with reference to the requirement information for the capability information of the second device in the sensing demand information, the second device that performs the first sensing service together with the first device. In some embodiments, the first device determines, based on the dynamic capability information fed back by the candidate second device and location information of the candidate second device and with reference to the requirement information for the capability information of the second device in the sensing demand information, the second device that performs the first sensing service together with the first device.

It can be understood that the first device sends capability enquiry information to all candidate second devices having the communication connection relationship with the first device as shown in FIG. 8 and FIG. 9, all the candidate second devices feed back dynamic capability information to the first device, and the first device determines, based on the dynamic capability information fed back by all the candidate second devices, the second device that performs the first sensing service together with the first device.

### Option 4:

the first device sends the sensing demand information and the first request information to all candidate second devices having a first communication connection relationship with the first device and matching the sensing target location and/or the sensing target area, where the first request information is used to instruct the candidate second device to feed back whether the first sensing service is able to be performed; and
the first device receives the first feedback information fed back by the candidate second device, and the first device determines the second device that performs the first sensing service together with the first device from the candidate second device feeding back that the first sensing service is able to be performed, where the first feedback information is used to indicate whether the candidate second device is able to perform the first sensing service. In some embodiments, the first device determines, with reference to location information of the candidate second device feeding back that the first sensing service is able to be performed, the second device that performs the first sensing service together with the first device from the candidate second device feeding back that the first sensing service is able to be performed.

It can be understood that the first device sends sensing demand information and first request information to all candidate second devices having the communication connection relationship with the first device as shown in FIG. 8 and FIG. 9, where the first request information is used to instruct the candidate second device to feed back whether the first sensing service is able to be performed. All the candidate second devices determine, based on dynamic capability information thereof, whether the first sensing service is able to be performed, and make feedback to the first device. The first device determines the second device that performs the first sensing service together with the first device from the candidate second device feeding back that the first sensing service is able to be performed.

For example, based on the foregoing embodiments, the method further includes:
reporting, by the first device, change information of the dynamic capability information to the first sensing function network element.

It should be noted that, the change information of the dynamic capability information is used for the first sensing function network element to determine whether to perform device reselection.

In some embodiments, that the first device reports change information of the dynamic capability information to the first sensing function network element includes one of the following:
reporting, by the first device, the change information of the dynamic capability information to the first sensing function network element in a case that the dynamic capability information of the first device is changed;
reporting, by the first device, the change information of the dynamic capability information to the first sensing function network element in a case that a reporting period of the change information of the dynamic capability information of the first device arrives; and
reporting, by the first device, the change information of the dynamic capability information to the first sensing function network element in a case that the first device receives third capability enquiry information sent by the first sensing function network element, where the third capability enquiry information is used to instruct the first device to report the change information of the dynamic capability information.

In other words, a manner in which the first device reports the change information of the dynamic capability information includes the following options:
in a triggering mode: the first device actively reports the change information of the dynamic capability information to the first sensing function network element in a case that the dynamic capability information changes;
in a periodic mode: the first device periodically reports the change information of the dynamic capability information to the first sensing function network element; and
in a response mode: the first device reports the change information of the dynamic capability information to the first sensing function network element in a case of receiving third capability enquiry information sent by the first sensing function network element.

In some embodiments, the change information of the dynamic capability information includes at least one of the following:
dynamic capability information of all entries;
dynamic capability information of a changed entry;
dynamic capability information of a designated entry;
a part of dynamic capability information of all entries or a designated entry different from static capability information or historically reported dynamic capability information; and
whether dynamic capability information of a device currently performing a sensing service is able to meet the sensing demand information.

In some embodiments, in a case that the first device has reported the static capability information or the dynamic capability information to the first sensing function network element (manner 1, manner 2, or manner 3), the change information of the dynamic capability information reported by the first device may be the dynamic capability information of all entries, the dynamic capability information of a changed entry, the dynamic capability information of a designated entry, or a part of dynamic capability information of all entries or a designated entry different from static capability information or historically reported dynamic capability information.

In a case that the first device has not reported the static capability information and the dynamic capability information to the first sensing function network element (manner 4), the change information of the dynamic capability information reported by the first device is whether the dynamic capability information of the device currently performing the sensing service is able to meet the sensing demand information.

In this embodiment of the present disclosure, the definition for the wireless sensing capability information is given, as well as the method and process for the sensing function network element and the device to select, by using the wireless sensing capability information of the device, the device that performs the sensing service, and the method for changing the device that performs the sensing service, which may be applied to a scenario for integrated sensing and communication.

FIG. 10 is a second schematic flowchart of a wireless sensing method according to an embodiment of the present disclosure. As shown in FIG. 10, the method includes the following steps.

Step 1000. A first sensing function network element determines, based on wireless sensing capability information and sensing demand information, a target device to perform a first sensing service.

The wireless sensing capability information is from one or more devices scheduled by a first sensing function network element; and the sensing demand information includes description of capability information required to perform the first sensing service.

The device herein may be a base station, UE, TRP, RIS, AP, and the like.

It should be noted that, the wireless sensing capability information is an information set used to represent whether a sensing service is able to be performed or a performance level that is able to be achieved around the sensing service in a case that the sensing service is able to be performed.

For the definition of the wireless sensing capability information, refer to the description in the first device side, and details are not described herein again.

The method that the first sensing function network element selects a device to perform the first sensing service includes the following manner 1 to manner 5. Details are described below.

### Manner 1:

refer to FIG. 4, that the first sensing function network element determines, based on wireless sensing capability information and sensing demand information, a target device to perform a first sensing service includes:
determining, by the first sensing function network element based on static capability information and location information of all devices scheduled by the first sensing function network element, and the sensing demand information, a candidate device that possibly has a capability to perform the first sensing service;
sending, by the first sensing function network element, second capability enquiry information to the candidate device, where the second capability enquiry information is used to instruct the candidate device to feed back dynamic capability information; and
receiving, by the first sensing function network element, the dynamic capability information sent by the candidate device, and determining, based on the received dynamic capability information, the target device to perform the first sensing service.

It can be understood that, the first sensing function network element performs preliminary screening based on static capability information and location information of devices in the first set and with reference to sensing demand information, to determine a candidate device that possibly has a capability to perform the first sensing service, where the sensing demand information includes description of capability information required to perform the first sensing service. The first set is a set of all devices scheduled by the first sensing function network element. The candidate devices form a second set, and locations of the candidate devices match the sensing target location and/or the sensing target area. Further, the first sensing function network element sends second capability enquiry information to the candidate devices in the second set, to instruct the candidate devices to feed back dynamic capability information. Further, the first sensing function network element determines, based on the dynamic capability information sent by the candidate devices, a target device to perform the first sensing service. In some embodiments, the first sensing function network element determines, based on the dynamic capability information sent by the candidate device with reference to location information of the candidate device and the sensing demand information, the target device to perform the first sensing service.

In some embodiments, before the first sensing function network element determines, based on static capability information and location information of all devices scheduled by the first sensing function network element, and the sensing demand information, a candidate device that possibly has a capability to perform the first sensing service, the method further includes:
obtaining static capability information of all devices scheduled by the first sensing function network element; and
storing the static capability information to the first sensing function network element or a network node accessible to the first sensing function network element.

In some embodiments, the obtaining static capability information of all the devices scheduled by the first sensing function network element includes at least one of the following:
receiving complete information or partial information of static capability information reported by the device scheduled by the first sensing function network element;
receiving level information reported by the device scheduled by the first sensing function network element, and obtaining the static capability information based on the level information;
receiving a device type and/or software version information and/or hardware version information reported by the device scheduled by the first sensing function network element, and obtaining the static capability information based on the device type and/or the software version information and/or the hardware version information; and
receiving an identification code of the static capability information reported by the device scheduled by the first sensing function network element, and obtaining the static capability information based on the identification code of the static capability information.

In some embodiments, the content indicated by the second capability enquiry information includes:
indicating reporting dynamic capability information of all entries; or
indicating reporting dynamic capability information of a designated entry.

In some embodiments, the received dynamic capability information includes at least one of the following:
receiving complete information of dynamic capability information of all entries or a designated entry reported by the candidate device based on indication of the second capability enquiry information;
receiving a part of the dynamic capability information of all entries or a designated entry that is different from the static capability information of a corresponding entry reported by the candidate device based on indication of the second capability enquiry information; and
receiving a part of the dynamic capability information of all entries or a designated entry that is different from historically reported dynamic capability information of a corresponding entry reported by the candidate device based on indication of the second capability enquiry information.

In the manner 1, the first device reports both the static capability information and the dynamic capability information. After performing preliminary screening based on the static capability information of the device, the first sensing function network element further determines, based on the dynamic capability information of the device, the device that performs the first sensing service.

### Manner 2:

refer to FIG. 5, that the first sensing function network element determines, based on wireless sensing capability information and sensing demand information, a target device to perform a first sensing service includes:
determining, by the first sensing function network element based on static capability information and location information of all devices scheduled by the first sensing function network element, and the sensing demand information, a candidate device that possibly has a capability to perform the first sensing service;
sending, by the first sensing function network element, the sensing demand information and first request information to the candidate device, where the first request information is used to instruct the candidate device to feed back whether the first sensing service is able to be performed; and
receiving, by the first sensing function network element, first feedback information sent by the candidate device, and determining a target device to perform the first sensing service from the candidate device feeding back that the first sensing service is able to be performed, where the first feedback information is used to indicate whether the candidate device is able to perform the first sensing service.

It can be understood that, the first sensing function network element performs preliminary screening based on static capability information and location information of devices in the first set and with reference to sensing demand information, to determine a candidate device that possibly has a capability to perform the first sensing service, where the sensing demand information includes description of capability information required to perform the first sensing service. The first set is a set of all devices scheduled by the first sensing function network element. The candidate devices form a second set, and locations of the candidate devices match the sensing target location and/or the sensing target area. Further, the first sensing function network element sends the sensing demand information and first request information to candidate devices in the second set, where the first request information is used to instruct the candidate devices in the second set to feed back whether the first sensing service is able to be performed. Further, the first sensing function network element determines a target device to perform the first sensing service from the candidate device feeding back that the first sensing service is able to be performed. In some embodiments, the first sensing function network element determines, with reference to location information of the candidate device feeding back that the first sensing service is able to be performed, a target device to perform the first sensing service from the candidate device feeding back that the first sensing service is able to be performed.

In some embodiments, before the first sensing function network element determines, based on static capability information and location information of all devices scheduled by the first sensing function network element, and the sensing demand information, a candidate device that possibly has a capability to perform the first sensing service, the method further includes:
obtaining static capability information of all devices scheduled by the first sensing function network element; and
storing the static capability information to the first sensing function network element or a network node accessible to the first sensing function network element.

In some embodiments, the obtaining static capability information of all the devices scheduled by the first sensing function network element includes at least one of the following:
receiving complete information or partial information of static capability information reported by the device scheduled by the first sensing function network element;
receiving level information reported by the device scheduled by the first sensing function network element, and obtaining the static capability information based on the level information;
receiving a device type and/or software version information and/or hardware version information reported by the device scheduled by the first sensing function network element, and obtaining the static capability information based on the device type and/or the software version information and/or the hardware version information; and
receiving an identification code of the static capability information reported by the device scheduled by the first sensing function network element, and obtaining the static capability information based on the identification code of the static capability information.

In the manner 2, the first device reports the static capability information, and does not report the dynamic capability information. After the first sensing function network element performs preliminary screening based on the static capability information of the device, further, a device obtained through preliminary screening determines, based on dynamic capability information thereof and the sensing demand information, whether the first sensing service is able to be performed. Then the first sensing function network element determines a target device to perform the first sensing service from the device feeding back that the first sensing service is able to be performed.

### Manner 3:

refer to FIG. 6, that the first sensing function network element determines, based on wireless sensing capability information and sensing demand information, a target device to perform a first sensing service includes:
determining, by the first sensing function network element based on location information of all devices scheduled by the first sensing function network element and the sensing demand information, a candidate device that performs the first sensing service;
sending, by the first sensing function network element, second capability enquiry information to the candidate device, where the second capability enquiry information is used to instruct the candidate device to report dynamic capability information; and
receiving, by the first sensing function network element, the dynamic capability information sent by the candidate device, and determining, by the first sensing function network element based on the received dynamic capability information, the target device to perform the first sensing service from the candidate device.

It can be understood that, the first sensing function network element performs preliminary screening based on location information of devices in the first set with reference to sensing demand information, to determine a candidate device that performs the first sensing service. Candidate devices form a second set. Locations of the candidate devices match the sensing target location and/or the sensing target area, and the first set is a set including all devices scheduled by the first sensing function network element. Further, the first sensing function network element sends second capability enquiry information to the candidate devices in the second set, to instruct the candidate devices in the second set to feed back dynamic capability information. Further, the first sensing function network element determines, based on the dynamic capability information sent by the candidate devices, a target device to perform the first sensing service. In some embodiments, the first sensing function network element determines, based on the dynamic capability information sent by the candidate devices with reference to location information of the candidate devices and the sensing demand information, the target device to perform the first sensing service.

In some embodiments, the content indicated by the second capability enquiry information includes:
indicating reporting dynamic capability information of all entries; or
indicating reporting dynamic capability information of a designated entry.

In some embodiments, the received dynamic capability information includes at least one of the following:
receiving complete information of dynamic capability information of all entries or a designated entry reported by the candidate device based on indication of the second capability enquiry information; and
receiving a part of the dynamic capability information of all entries or a designated entry that is different from historically reported dynamic capability information of a corresponding entry reported by the candidate device based on indication of the second capability enquiry information.

In the manner 3, the first device does not report the static capability information, but reports the dynamic capability information. After the first sensing function network element performs preliminary screening based on location information of the device and the sensing demand information, further, second capability enquiry information is sent to the device obtained through preliminary screening, to obtain dynamic capability information of the device obtained through preliminary screening, and then the target device to perform the first sensing service is determined based on the dynamic capability information.

### Manner 4:

refer to FIG. 7, that the first sensing function network element determines, based on wireless sensing capability information and sensing demand information, a target device to perform a first sensing service includes:
determining, by the first sensing function network element based on location information of all devices scheduled by the first sensing function network element and the sensing demand information, a candidate device that performs the first sensing service;
sending, by the first sensing function network element, the sensing demand information and first request information to the candidate device, where the first request information is used to instruct the candidate device to feed back whether the first sensing service is able to be performed; and
receiving, by the first sensing function network element, first feedback information sent by the candidate device, and determining, by the first sensing function network element based on the received first feedback information, a target device to perform the first sensing service from the candidate device feeding back that the first sensing service is able to be performed, where the first feedback information is used to indicate whether the candidate device is able to perform the first sensing service.

It can be understood that, the first sensing function network element performs preliminary screening based on location information of devices in the first set with reference to sensing demand information, to determine a candidate device that performs the first sensing service. Candidate devices form a second set. Locations of the candidate devices match the sensing target location and/or the sensing target area, and the first set is a set including all devices scheduled by the first sensing function network element. Further, the first sensing function network element sends the sensing demand information and first request information to candidate devices in the second set, to instruct the candidate devices in the second set to feed back whether the first sensing service is able to be performed. Further, the first sensing function network element determines a target device to perform the first sensing service from the candidate device feeding back that the first sensing service is able to be performed. In some embodiments, the first sensing function network element determines, with reference to location information of the candidate device feeding back that the first sensing service is able to be performed, a target device to perform the first sensing service from the candidate device feeding back that the first sensing service is able to be performed.

In the manner 4, the first device reports neither the static capability information nor the dynamic capability information. After the first sensing function network element performs preliminary screening based on location information of all scheduled devices and the sensing demand information, further, the sensing demand information and the first request information are sent to the device obtained through preliminary screening. The device obtained through preliminary screening determines, based on dynamic capability information thereof and the sensing demand information, whether the first sensing service is able to be performed. Then the first sensing function network element determines a target device to perform the first sensing service from the device feeding back that the first sensing service is able to be performed.

It should be noted that, the target device in the embodiments of the present disclosure may be one device or a combination of a plurality of devices.

In some embodiments, applicable to the manner 1 to the manner 4, after the first sensing function network element determines, based on wireless sensing capability information and sensing demand information, a target device to perform a first sensing service, the method further includes:
sending first sensing start information to the target device, where the first sensing start information is used to instruct the target device to perform the first sensing service.

Particularly, in the manner 1 and the manner 3, the sensing demand information is sent to the target device in addition to the first sensing start information.

### Manner 5:

In the application of integrated sensing and communication, many examples involve receiving/transmitting among a plurality of devices; for example, an example of bistatic radar, pedestrian flow detection/vehicle flow detection/intrusion detection based on signal attenuation between devices, breath detection and action recognition based on reflected signals, and the like. In this case, capabilities of a plurality of devices that participate in sensing are required to meet tasks respectively. For example, in a bistatic radar scenario, a transmit end device needs to have enough transmission power, while a receive end device needs to have enough angle measurement capability, and the like.

That a sensing task involves two devices is used as an example for description. This involves the sensing function network element, the first device, and the second device. The “first” and “second” only indicate the distinction between two devices without any limitation on functions or attributes of the devices.

A communication connection relationship between the sensing function network element and the first device, the second device and a corresponding information interaction method are divided into the following two cases:
1) the sensing function network element communicates directly with both the first device and the second device, as shown in FIG. 8. In this case, the sensing function network element may directly interact information with the first device or the second device; and
2) the sensing function network element communicates directly with only one of the first device and the second device, and the first device communicates directly with the second device, as shown in FIG. 9. In this case, a device that communicates directly with the sensing function network element may directly interact information with the sensing function network element, and a device that cannot communicate directly with the sensing function network element requires forwarding from the device that communicates directly with the sensing function network element for interaction with the sensing function network element.

The method that the first sensing function network element selects a device for performing the first sensing service includes the following two cases.

1) The first sensing function network element selects the first device and the second device.

That the first sensing function network element selects the first device and the second device for performing the first sensing service together includes: determining, by the first sensing function network element based on requirement information for capability information of a first device in the sensing demand information, the first device, and determining, by the first sensing function network element based on requirement information for capability information of a second device in the sensing demand information, the second device that performs the first sensing service together with the first device.

When the first device and the second device are selected, on the one hand, the device capability information should be considered, on the other hand, a relative location relationship between the first device, the second device and the sensing target location and/or the sensing target area should be considered.

Interaction of device capability information between the sensing function network element and the first device, the second device may be one of the two information interaction methods in FIG. 8 and FIG. 9.

In this case, the first sensing function network element may select the first device in the method of the manner 1, the manner 2, the manner 3, or the manner 4, and the first sensing function network element may select the second device in the method of the manner 1, the manner 2, the manner 3, or the manner 4.

2) The sensing function network element selects the first device, and the first device selects the second device.

The first sensing function network element may use the method in the manner 1, the manner 2, the manner 3, or the manner 4 to determine the first device with reference to the requirement information for the capability information of the first device in the sensing demand information.

After determining, based on requirement information for capability information of a first device in the sensing demand information, the first device, the first sensing function network element sends the sensing demand information to the first device, so that the first device determines, based on requirement information for capability information of a second device in the sensing demand information, the second device that performs the first sensing service together with the first device.

For the method that the first device determines, based on the requirement information for the capability information of the second device in the sensing demand information, the second device that performs the first sensing service together with the first device, details are not described herein again.

For example, based on the foregoing embodiments, the method further includes:
receiving, by the first sensing function network element, change information of the dynamic capability information;
determining, by the first sensing function network element based on the change information of the dynamic capability information and the sensing demand information, whether to perform device reselection; and
in a case that it is determined to perform device reselection, reselecting, by the first sensing function network element, a device to perform the first sensing service.

In some embodiments, the change information of the dynamic capability information includes one of the following:
dynamic capability information of all entries;
dynamic capability information of a changed entry;
dynamic capability information of a designated entry;
a part of dynamic capability information of all entries or a designated entry different from static capability information or historically reported dynamic capability information; and
whether dynamic capability information of a device currently performing the first sensing service is able to meet the sensing demand information.

In some embodiments, a manner of reporting the change information of the dynamic capability information includes the following options:
in a triggering mode: the device actively reports the change information of the dynamic capability information to the first sensing function network element in a case that the dynamic capability information changes;
in a periodic mode: the device periodically reports the change information of the dynamic capability information to the first sensing function network element; and
in a response mode: the device reports the change information of the dynamic capability information to the first sensing function network element in a case of receiving third capability enquiry information sent by the first sensing function network element.

After the first sensing function network element receives the change information of the dynamic capability information reported by the device, there are two processing options.

In some embodiments, that the first sensing function network element determines, based on the change information of the dynamic capability information and the sensing demand information, whether to perform device reselection includes:
determining to perform device reselection in a case that the device reporting the change information of the dynamic capability information is a device currently performing the first sensing service, and a first condition is met, where
the first condition includes one of the following:
the change information of the dynamic capability information is the dynamic capability information of all the entries, the dynamic capability information of the changed entry, the dynamic capability information of the designated entry, or the part of dynamic capability information of all entries or a designated entry different from static capability information or historically reported dynamic capability information; the first sensing function network element obtains, based on the change information of the dynamic capability information, changed dynamic capability information of the device currently performing the first sensing service, and the changed dynamic capability information is not able to meet the sensing demand information; or a deviation between the changed dynamic capability information and capability information required by the sensing demand information exceeds a first preset threshold; and
the change information of the dynamic capability information indicates that the dynamic capability information of the device currently performing the first sensing service is not able to meet the sensing demand information.

It can be understood that, when the first sensing function network element receives the change information of the dynamic capability information reported by the device currently performing the first sensing service, and the change information of the dynamic capability information is the dynamic capability information of all the entries, the dynamic capability information of the changed entry, the dynamic capability information of the designated entry, or the part of dynamic capability information of all entries or a designated entry different from static capability information or historically reported dynamic capability information, changed dynamic capability information of the device currently performing the first sensing service is obtained based on the change information of the dynamic capability information. The first sensing function network element matches the changed dynamic capability information with a sensing demand: if the changed dynamic capability information can still meet the sensing demand information, the first sensing function network element does not process; and if the changed dynamic capability information cannot meet the sensing demand information, or the deviation between the changed dynamic capability information and the capability information required by the sensing demand information exceeds the first preset threshold, the first sensing function network element performs device reselection.

If the first sensing function network element receives the change information of the dynamic capability information reported by the device currently performing the first sensing service, and the change information of the dynamic capability information indicates that the dynamic capability information of the device currently performing the first sensing service is not able to meet the sensing demand information, the first sensing function network element performs device reselection; and if the change information of the dynamic capability information indicates that the dynamic capability information of the device currently performing the first sensing service is able to meet the sensing demand information, the first sensing function network element does not process.

Based on the foregoing embodiment, that the first sensing function network element reselects a device to perform the first sensing service includes:
sending, by the first sensing function network element, the second capability enquiry information to a candidate device that matches the sensing target location and/or the sensing target area and matches the static capability information or the historically reported dynamic capability information, where the second capability enquiry information is used to instruct the candidate device to report the dynamic capability information; and
in a case that the first sensing function network element receives the dynamic capability information reported by the candidate device, and there is a third device, in the candidate device, with a matching degree between dynamic capability information and sensing demand information higher than a matching degree between dynamic capability information and sensing demand information of the target device, switching, by the first sensing function network element, the device that performs the first sensing service from the target device to the third device.

It can be understood that if there is no candidate device with a matching degree between the dynamic capability information and the sensing demand information higher than a matching degree between the dynamic capability information and the sensing demand information of the target device, the first sensing function network element does not perform switch.

In some embodiments, that the first sensing function network element determines, based on the change information of the dynamic capability information and the sensing demand information, whether to perform device reselection includes:
determining to perform device reselection in a case that the device reporting the change information of the dynamic capability information is not the device currently performing the first sensing service, and a second condition is met, where
the second condition includes:
the dynamic capability information of the device currently performing the first sensing service is not able to meet the sensing demand information, changed dynamic capability information of the device reporting the change information of the dynamic capability information is able to meet the sensing demand information, and location information of the device reporting the change information of the dynamic capability information matches the sensing target location and/or the sensing target area; and
that the first sensing function network element reselects a device to perform the first sensing service includes:
switching, by the first sensing function network element, the device that performs the first sensing service to the device reporting the change information of the dynamic capability information.

It should be noted that, in the process of the device selection method described in the manner 1, the manner 2, and the manner 3, the first sensing function network element selects at least one standby device (which may be recorded as a standby device group) in addition to the target device (the first device). The standby device is a device, determined by the first sensing function network element in a process of determining the target device, for which a deviation between static capability information or dynamic capability information and capability information required by the sensing demand information is less than a first preset threshold, and a deviation between the location information and the sensing target location and/or the sensing target area is less than a second preset threshold.

In some embodiments, the method further includes:
selecting, by the first sensing function network element, at least one standby device, and sending third capability enquiry information to the at least one standby device, where the third capability enquiry information is used to instruct the standby device to report change information of the dynamic capability information.

When a standby device in the standby device group reports a change of dynamic capability information thereof to the sensing function network element, the sensing function network element matches changed dynamic capability information of the standby device with the dynamic capability information and the sensing demand information of the target device, and the device is switched in the following cases: if the dynamic capability information of the target device cannot meet the sensing demand information, but the changed dynamic capability information of the standby device can meet the sensing demand information, and the location information of the standby device matches the sensing target location and/or the sensing target area, the device that performs a sensing task is switched to the standby device.

It is worth noting that the target device (optimal device) in the foregoing embodiment does not necessarily meet the sensing demand information, or it may be that all devices scheduled by the first sensing function network element cannot meet the sensing demand information, and the deviation between the dynamic capability information of the target device (optimal device) and the capability information required by the sensing demand information is the smallest.

In some embodiments, the method further includes:
in a case that a third condition is met, reselecting, by the first sensing function network element, a device to perform the first sensing service, where
the third condition includes at least one of the following:
receiving a device conflict message, where the device conflict message is used to instruct the first sensing function network element to reselect a device to perform the first sensing service; and
the target device currently performing the first sensing service is not able to continue to perform the first sensing service.

In some embodiments, that the target device to perform the first sensing service is not able to continue to perform the first sensing service includes at least one of the following:
relative movement between a sensing target corresponding to the first sensing service and the target device causes a location of the sensing target beyond coverage of the target device in performing the first sensing service; and
movement of the target device causes the coverage of the target device in performing the first sensing service to be not able to contain the sensing target location and/or the sensing target area.

It can be understood that in a case that the device conflict message sent by the device is received, or in a case that the target device currently performing the first sensing service cannot continue to perform the first sensing service due to movement of the target device or the relative movement between the sensing target corresponding to the first sensing service and the target device, the first sensing function network element may also reselect a device to perform the first sensing service.

In this embodiment of the present disclosure, the definition for the wireless sensing capability information is given, as well as the method and process for the sensing function network element and the device to select, by using the wireless sensing capability information of the device, the device that performs the sensing service, and the method for changing the device that performs the sensing service, which may be applied to a scenario for integrated sensing and communication.

The wireless sensing method provided in this embodiment of the present disclosure may be executed by a wireless sensing apparatus. In this embodiment of the present disclosure, the wireless sensing apparatus provided in this embodiment of the present disclosure is described by using an example in which the wireless sensing apparatus performs the wireless sensing method.

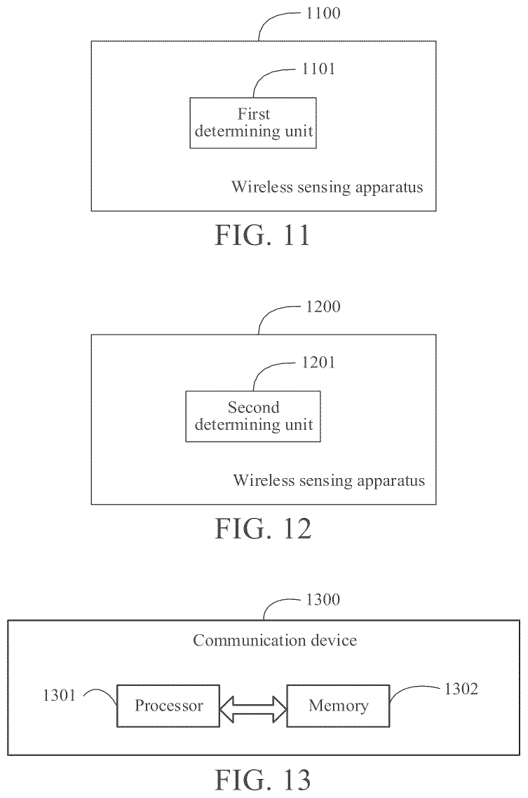

FIG. 11 is a first schematic diagram of a structure of a wireless sensing apparatus according to an embodiment of the present disclosure. As shown in FIG. 11, the wireless sensing apparatus 1100 includes:
a first determining unit 1101, configured to determine wireless sensing capability information, where the wireless sensing capability information is an information set used to represent whether a sensing service is able to be performed or a performance level that is able to be achieved around the sensing service in a case that the sensing service is able to be performed.

In some embodiments, the wireless sensing capability information includes: a first capability set and/or a second capability set, where the first capability set is a sensing-enhanced capability set existing in communication; and the second capability set is a sensing-specific capability set.

In some embodiments, the first capability set includes at least one of the following:
a frequency-related capability;
a power-related capability; and
a beam-related capability;
and/or
the second capability set includes at least one of the following:
a capability for sensing a radio frequency;
a supported sensing service type;
a supported sensing signal waveform;
a supported sensing measurement quantity;
a supported sensing indicator;
a supported control or scheduling capability related to sensing; and
a capability of assistance information related to sensing.

In some embodiments, the frequency-related capability includes at least one of the following:
a band or a band combination supporting a sensing function and a bandwidth of each band or band combination;
a receive/transmit capability of a sensing signal supported by each band or band combination; and
a quantity of independent radio frequency channels or a quantity of antennas or an antenna layout for receiving/transmitting the sensing signal supported by each band or band combination.

In some embodiments, the power-related capability includes at least one of the following:
a supported power level of the sensing signal, and/or a maximum peak power of the sensing signal, and/or a maximum average power of the sensing signal;
a supported maximum transmission time ratio of the sensing signal, and/or a maximum transmission power of the sensing signal for a given transmission time ratio;
whether to support power adaptive adjustment of the sensing signal, and/or a power control parameter; and
whether to support a maximum power back-off mechanism, and/or a supported maximum power back-off value.

In some embodiments, the beam-related capability includes at least one of the following:
whether to support sensing signal transmitting beam scanning and/or receiving beam scanning;
whether to support sensing signal transmitting beam selection and/or receiving beam selection;
whether to support sensing signal transmitting beam adaptation and/or receiving beam adaptation;
whether to support sensing signal transmitting beamforming and/or receiving beamforming; and
whether to support sensing signal beam measurement and a beam report.

In some embodiments, the capability for sensing a radio frequency includes at least one of the following:
whether to support bandwidth splicing of the sensing signal and corresponding signal processing;
whether to support simultaneous transmission of multiple beams, where the multiple beams include at least one of the following: a communication beam, a sensing beam, and a communication sensing beam;
a switching speed of the sensing beam; and
whether to support frequency hopping of the sensing signal.

In some embodiments, the sensing service type includes at least one of the following:
a radar detection service;
a user positioning and tracking service;
a three-dimensional reconstruction service;
a weather and/or air quality detection service;
a pedestrian and/or vehicle flow detection service;
a health monitoring service;
an action recognition service; and
sensing signal transmission or reception based on RFID or backscatter.

In some embodiments, the supported sensing signal waveform includes at least one of the following:
supporting transmission and/or reception, and/or transmission and reception through time division, and/or simultaneous transmission and reception of a communication dominant signal;
supporting transmission and/or reception, and/or transmission and reception through time division, and/or simultaneous transmission and reception of a sensing dominant signal;
supporting transmission and/or reception, and/or transmission and reception through time division, and/or simultaneous transmission and reception of a sensing-enhanced communication dominant signal; and
supporting transmission and/or reception, and/or transmission and reception through time division, and/or simultaneous transmission and reception of a signal for integrated sensing and communication.

In some embodiments, the supported sensing measurement quantity includes at least one of the following:
original channel information, where the original channel information includes at least one of the following: a channel matrix or compressed quantization information of the channel matrix, channel state information, I-channel and Q-channel signal features of a frequency domain channel response;
signal strength information, where the signal strength information includes at least one of the following: RSRP and RSSI;
spectrum information, where the spectrum information includes at least one of following: a channel power delay profile, a Doppler power spectrum, a power angle spectrum, pseudo-spectral information, a delay-Doppler two-dimensional spectrum, and a delay-Doppler-angle three-dimensional spectrum;
multipath information, where the multipath information includes at least one of following: a power, a phase, a delay, and angle information of each path in a multipath channel;
angle information, where the angle information includes at least one of following: an angle of arrival and an angle of departure;
difference information of signals corresponding to different antennas, where the difference information of signals corresponding to different antennas includes at least one of the following: quotient or conjugate multiplication of frequency domain channel responses of a first antenna and a second antenna, an amplitude ratio or an amplitude difference between received signals of the first antenna and the second antenna, a phase difference between signals of the first antenna and the second antenna, and a delay difference between signals of the first antenna and the second antenna, where
target parameter information determined based on the original channel information, where the target parameter information includes at least one of the following: Doppler spread, Doppler frequency shift, maximum delay spread, angle spread, a coherence bandwidth, and a coherence time;
radar point cloud information; and
a measurement quantity obtained by performing calculation based on at least two items of the original channel information, the signal strength information, the spectrum information, the multipath information, the angle information, the difference information of signals corresponding to different antennas, the target parameter information, and the radar point cloud information.

In some embodiments, the supported sensing indicator includes at least one of the following:
a sensing coverage;
a sensing resolution;
sensing accuracy;
a sensing delay-related capability;
a sensing update rate;
a detection probability; and
a false alarm probability.

In some embodiments, the supported control or scheduling capability related to sensing includes at least one of the following:
whether to support simultaneously scheduling of communication and sensing control information;
a quantity of services supported simultaneously or through time division in a time unit;
whether to support indicating and/or reporting at least one of a sensing service type, a sensing signal waveform, and a sensing measurement quantity by using physical layer signaling; and
a physical layer buffer size for temporary storage of sensing data, where the sensing data includes at least one of the following: configuration information used for sensing and a sensing measurement quantity.

In some embodiments, the capability of assistance information related to sensing includes at least one of the following:
mobility of a device; and
a capability and accuracy for obtaining a location, a posture, or motion information of the device.

In some embodiments, a granularity of the wireless sensing capability information includes at least one of the following: per band/band combination, per service/service category, and per device.

In some embodiments, the wireless sensing capability information includes at least one of the following:
static capability information, where the static capability information is information for representing an inherent capability of the device determined by a software and/or hardware configuration of the device; and
dynamic capability information, where the dynamic capability information is information for representing an available capability of sensing service.

In some embodiments, the apparatus further includes:
a first sending unit, configured to report the static capability information of the first device to the first sensing function network element, where
the first sending unit is configured to perform one of the following:
reporting the static capability information of the first device immediately after the first device accesses a first network;
reporting the static capability information of the first device in a case that the first device is in an idle state after accessing the first network; and
reporting the static capability information of the first device in a case that first capability enquiry information sent by the first sensing function network element is received, where the first capability enquiry information is used to instruct the first device to report the static capability information, where
the first network is a network corresponding to the first sensing function network element.

In some embodiments, the reporting the static capability information of the first device to a first sensing function network element includes one of the following:
reporting complete information of the static capability information of the first device to the first sensing function network element;
reporting level information corresponding to the static capability information of the first device to the first sensing function network element;
reporting partial information in the static capability information of the first device to the first sensing function network element;
reporting a device type and/or software version information and/or hardware version information of the first device to the first sensing function network element; and
reporting an identification code of the static capability information of the first device to the first sensing function network element.

In some embodiments, the apparatus further includes:
a first receiving unit, configured to receive second capability enquiry information sent by the first sensing function network element, where the second capability enquiry information is used to instruct the first device to report the dynamic capability information; and
a second sending unit, configured to report the dynamic capability information of the first device to the first sensing function network element.

In some embodiments, the reporting the dynamic capability information of the first device to the first sensing function network element includes at least one of the following:
reporting, based on indication of the second capability enquiry information, complete information of dynamic capability information of all entries or a designated entry;
reporting, based on indication of the second capability enquiry information, a part of the dynamic capability information of all entries or a designated entry that is different from the static capability information of a corresponding entry; and
reporting, based on indication of the second capability enquiry information, a part of the dynamic capability information of all entries or a designated entry that is different from historically reported dynamic capability information of a corresponding entry.

In some embodiments, the apparatus further includes:
a second receiving unit, configured to receive sensing demand information and first request information sent by the first sensing function network element, where the first request information is used to instruct the first device to feed back whether a first sensing service is able to be performed;
a first determining unit, configured to determine, based on the sensing demand information and the dynamic capability information of the first device, whether the first sensing service is able to be performed; and
a third sending unit, configured to send first feedback information to the first sensing function network element, where the first feedback information is used to indicate whether the first device is able to perform the first sensing service.

In some embodiments, the apparatus further includes:
a third receiving unit, configured to receive first sensing start information sent by the first sensing function network element, where the first sensing start information is used to instruct the first device to perform the first sensing service.

In some embodiments, the apparatus further includes: a first processing unit, configured to:
perform the first sensing service in a case that the first device receives second sensing start information sent by a second sensing function network element, and a priority of the first sensing service is higher than a priority of a second sensing service indicated by the second sensing start information; or
skip performing the first sensing service, and report a device conflict message to the first sensing function network element in a case that the first device receives second sensing start information sent by a second sensing function network element, and a priority of the first sensing service is lower than or equal to a priority of a second sensing service indicated by the second sensing start information, where the device conflict message is used to instruct the first sensing function network element to reselect a device to perform the first sensing service.

In some embodiments, the apparatus further includes: a second processing unit, configured to:
receive the sensing demand information sent by the first sensing function network element, and determine, based on requirement information for capability information of the second device in the sensing demand information, the second device that performs the first sensing service together with the first device;
or
determine, based on requirement information for capability information of the second device in the sensing demand information, the second device that performs the first sensing service together with the first device.

In some embodiments, the determining, based on requirement information for capability information of the second device in the sensing demand information, the second device that performs the first sensing service together with the first device includes:
selecting, based on static capability information of a candidate device and the requirement information for the capability information of the second device in the sensing demand information, one or more candidate second devices from the candidate device, where the candidate second device matches a sensing target location and/or a sensing target area, and the candidate device is a device scheduled by the first sensing function network element other than the first device;
sending the second capability enquiry information to the candidate second device and receiving dynamic capability information fed back by the candidate second device, where the second capability enquiry information is used to instruct the candidate second device to feed back the dynamic capability information; and
receiving the dynamic capability information fed back by the candidate second device, and determining, based on the dynamic capability information fed back by the candidate second device, the second device that performs the first sensing service together with the first device;
or
selecting, based on static capability information of a candidate device and the requirement information for the capability information of the second device in the sensing demand information, one or more candidate second devices from the candidate device, where the candidate second device matches a sensing target location and/or a sensing target area, and the candidate device is a device scheduled by the first sensing function network element other than the first device;
sending the sensing demand information and the first request information to the candidate second device, and receiving the first feedback information sent by the candidate second device, where the first request information is used to instruct the candidate second device to feed back whether the first sensing service is able to be performed, and the first feedback information is used to indicate whether the candidate second device is able to perform the first sensing service; and
determining the second device that performs the first sensing service together with the first device from the candidate second device feeding back that the first sensing service is able to be performed;
or
sending the second capability enquiry information to all candidate second devices having a first communication connection relationship with the first device and matching the sensing target location and/or the sensing target area, where the second capability enquiry information is used to instruct the candidate second device to feed back the dynamic capability information; and
receiving the dynamic capability information fed back by the candidate second device, and determining, by the first device based on the dynamic capability information fed back by the candidate second device and with reference to the requirement information for the capability information of the second device in the sensing demand information, the second device that performs the first sensing service together with the first device;
or
sending the sensing demand information and the first request information to all candidate second devices having a first communication connection relationship with the first device and matching the sensing target location and/or the sensing target area, where the first request information is used to instruct the candidate second device to feed back whether the first sensing service is able to be performed; and
receiving the first feedback information fed back by the candidate second device, and determining, by the first device, the second device that performs the first sensing service together with the first device from the candidate second device feeding back that the first sensing service is able to be performed, where the first feedback information is used to indicate whether the candidate second device is able to perform the first sensing service.

In some embodiments, the apparatus further includes:
a fourth sending unit, configured to report change information of the dynamic capability information to the first sensing function network element.

In some embodiments, the reporting change information of the dynamic capability information to the first sensing function network element includes one of the following:
reporting, by the first device, the change information of the dynamic capability information to the first sensing function network element in a case that the dynamic capability information of the first device is changed;
reporting, by the first device, the change information of the dynamic capability information to the first sensing function network element in a case that a reporting period of the change information of the dynamic capability information of the first device arrives; and
reporting, by the first device, the change information of the dynamic capability information to the first sensing function network element in a case that the first device receives third capability enquiry information sent by the first sensing function network element, where the third capability enquiry information is used to instruct the first device to report the change information of the dynamic capability information.

In some embodiments, the change information of the dynamic capability information includes at least one of the following:
dynamic capability information of all entries;
dynamic capability information of a changed entry;
dynamic capability information of a designated entry;
a part of dynamic capability information of all entries or a designated entry different from static capability information or historically reported dynamic capability information; and
whether dynamic capability information of a device currently performing the first sensing service is able to meet the sensing demand information.

In this embodiment of the present disclosure, the definition for the wireless sensing capability information is given, as well as the method and process for the sensing function network element and the device to select, by using the wireless sensing capability information of the device, the device that performs the sensing service, and the method for changing the device that performs the sensing service, which may be applied to a scenario for integrated sensing and communication.

The wireless sensing apparatus in this embodiment of the present disclosure may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11. The other device may be a server, a network attached storage (NAS), and the like. This is not specifically limited in this embodiment of the present disclosure.

The wireless sensing apparatus provided in this embodiment of the present disclosure can implement the processes implemented in the method embodiments from FIG. 3 to FIG. 7, and a same technical effect can be achieved. To avoid repetition, details are not described herein again.

FIG. 12 is a second schematic diagram of a structure of a wireless sensing apparatus according to an embodiment of the present disclosure. As shown in FIG. 12, the wireless sensing apparatus 1200 includes:
a second determining unit 1201, configured to determine, based on wireless sensing capability information and sensing demand information, a target device to perform a first sensing service, where
the wireless sensing capability information is from one or more devices scheduled by a first sensing function network element; and
the sensing demand information includes description of capability information required to perform the first sensing service.

In some embodiments, the second determining unit is configured to:
determine, based on static capability information and location information of all devices scheduled by the first sensing function network element, and the sensing demand information, a candidate device that possibly has a capability to perform the first sensing service;
send second capability enquiry information to the candidate device, where the second capability enquiry information is used to instruct the candidate device to feed back dynamic capability information; and
receive the dynamic capability information sent by the candidate device, and determine, based on the received dynamic capability information, the target device to perform the first sensing service.

In some embodiments, the second determining unit is configured to:
determine, based on static capability information and location information of all devices scheduled by the first sensing function network element, and the sensing demand information, a candidate device that possibly has a capability to perform the first sensing service;
send the sensing demand information and first request information to the candidate device, where the first request information is used to instruct the candidate device to feed back whether the first sensing service is able to be performed; and
receive first feedback information sent by the candidate device, and determine a target device to perform the first sensing service from the candidate device feeding back that the first sensing service is able to be performed, where the first feedback information is used to indicate whether the candidate device is able to perform the first sensing service.

In some embodiments, the second determining unit is configured to:
determine, based on location information of all devices scheduled by the first sensing function network element and the sensing demand information, a candidate device that performs the first sensing service;
send second capability enquiry information to the candidate device, where the second capability enquiry information is used to instruct the candidate device to report dynamic capability information; and
receive the dynamic capability information sent by the candidate device, and determine, based on the received dynamic capability information, the target device to perform the first sensing service from the candidate device.

In some embodiments, the second determining unit is configured to:
determine, based on location information of all devices scheduled by the first sensing function network element and the sensing demand information, a candidate device that performs the first sensing service;
send the sensing demand information and first request information to the candidate device, where the first request information is used to instruct the candidate device to feed back whether the first sensing service is able to be performed; and
receive first feedback information sent by the candidate device, and determine, based on the received first feedback information, a target device to perform the first sensing service from the candidate device feeding back that the first sensing service is able to be performed, where the first feedback information is used to indicate whether the candidate device is able to perform the first sensing service.

In some embodiments, the apparatus further includes:
a first obtaining unit, configured to obtain static capability information of all the devices scheduled by the first sensing function network element; and
a first storage unit, configured to store the static capability information to the first sensing function network element or a network node accessible to the first sensing function network element.

In some embodiments, the obtaining static capability information of all the devices scheduled by the first sensing function network element includes at least one of the following:
receiving complete information or partial information of static capability information reported by the device scheduled by the first sensing function network element;
receiving level information reported by the device scheduled by the first sensing function network element, and obtaining the static capability information based on the level information;
receiving a device type and/or software version information and/or hardware version information reported by the device scheduled by the first sensing function network element, and obtaining the static capability information based on the device type and/or the software version information and/or the hardware version information; and
receiving an identification code of the static capability information reported by the device scheduled by the first sensing function network element, and obtaining the static capability information based on the identification code of the static capability information.

In some embodiments, the received dynamic capability information includes at least one of the following:
receiving complete information of dynamic capability information of all entries or a designated entry reported by the candidate device based on indication of the second capability enquiry information;
receiving a part of the dynamic capability information of all entries or a designated entry that is different from the static capability information of a corresponding entry reported by the candidate device based on indication of the second capability enquiry information; and
receiving a part of the dynamic capability information of all entries or a designated entry that is different from historically reported dynamic capability information of a corresponding entry reported by the candidate device based on indication of the second capability enquiry information.

In some embodiments, the apparatus further includes:
a fifth sending unit, configured to send first sensing start information to the target device, where the first sensing start information is used to instruct the target device to perform the first sensing service.

In some embodiments, the second determining unit is configured to:
determine, based on requirement information for capability information of a first device in the sensing demand information, the first device, and determine, based on requirement information for capability information of a second device in the sensing demand information, the second device that performs the first sensing service together with the first device; or
determine, based on requirement information for capability information of a first device in the sensing demand information, the first device, and send the sensing demand information to the first device, so that the first device determines, based on requirement information for capability information of a second device in the sensing demand information, the second device that performs the first sensing service together with the first device.

In some embodiments, the apparatus further includes:
a fourth receiving unit, configured to receive change information of the dynamic capability information;
a third determining unit, configured to determine, based on the change information of the dynamic capability information and the sensing demand information, whether to perform device reselection; and
a third processing unit, configured to: in a case that it is determined to perform device reselection, reselect a device to perform the first sensing service.

In some embodiments, the change information of the dynamic capability information includes one of the following:
dynamic capability information of all entries;
dynamic capability information of a changed entry;
dynamic capability information of a designated entry;
a part of dynamic capability information of all entries or a designated entry different from static capability information or historically reported dynamic capability information; and
whether dynamic capability information of a device currently performing the first sensing service is able to meet the sensing demand information.

In some embodiments, the third determining unit is configured to:
determine to perform device reselection in a case that the device reporting the change information of the dynamic capability information is a device currently performing the first sensing service, and a first condition is met, where
the first condition includes one of the following:
the change information of the dynamic capability information is the dynamic capability information of all the entries, the dynamic capability information of the changed entry, the dynamic capability information of the designated entry, or the part of dynamic capability information of all entries or a designated entry different from static capability information or historically reported dynamic capability information; the first sensing function network element obtains, based on the change information of the dynamic capability information, changed dynamic capability information of the device currently performing the first sensing service, and the changed dynamic capability information is not able to meet the sensing demand information; or a deviation between the changed dynamic capability information and capability information required by the sensing demand information exceeds a first preset threshold; and
the change information of the dynamic capability information indicates that the dynamic capability information of the device currently performing the first sensing service is not able to meet the sensing demand information.

In some embodiments, the third processing unit is configured to:
send the second capability enquiry information to a candidate device that matches the sensing target location and/or the sensing target area and matches the static capability information or the historically reported dynamic capability information, where the second capability enquiry information is used to instruct the candidate device to report the dynamic capability information; and
in a case that the first sensing function network element receives the dynamic capability information reported by the candidate device, and there is a third device, in the candidate device, with a matching degree between dynamic capability information and sensing demand information higher than a matching degree between dynamic capability information and sensing demand information of the target device, switch the device that performs the first sensing service from the target device to the third device.

In some embodiments, the third determining unit is configured to:
determine to perform device reselection in a case that the device reporting the change information of the dynamic capability information is not the device currently performing the first sensing service, and a second condition is met, where
the second condition includes:
the dynamic capability information of the device currently performing the first sensing service is not able to meet the sensing demand information, changed dynamic capability information of the device reporting the change information of the dynamic capability information is able to meet the sensing demand information, and location information of the device reporting the change information of the dynamic capability information matches the sensing target location and/or the sensing target area.

In some embodiments, the third processing unit is configured to:
switch the device that performs the first sensing service to the device reporting the change information of the dynamic capability information.

In some embodiments, the method further includes:
a fourth processing unit, configured to: select at least one standby device, and send third capability enquiry information to the at least one standby device, where the third capability enquiry information is used to instruct the standby device to report change information of the dynamic capability information, where
the standby device is a device, determined by the first sensing function network element in a process of determining the target device, for which a deviation between static capability information or dynamic capability information and capability information required by the sensing demand information is less than a first preset threshold, and a deviation between the location information and the sensing target location and/or the sensing target area is less than a second preset threshold.

In some embodiments, the apparatus further includes:
a fifth processing unit, configured to: in a case that a third condition is met, reselect a device to perform the first sensing service, where
the third condition includes at least one of the following:
receiving a device conflict message, where the device conflict message is used to instruct the first sensing function network element to reselect a device to perform the first sensing service; and
the target device currently performing the first sensing service is not able to continue to perform the first sensing service.

In some embodiments, that the target device currently performing the first sensing service is not able to continue to perform the first sensing service includes at least one of the following:
relative movement between a sensing target corresponding to the first sensing service and the target device causes a location of the sensing target beyond coverage of the target device in performing the first sensing service; and
movement of the target device causes the coverage of the target device in performing the first sensing service to be not able to contain the sensing target location and/or the sensing target area.

In this embodiment of the present disclosure, the definition for the wireless sensing capability information is given, as well as the method and process for the sensing function network element and the device to select, by using the wireless sensing capability information of the device, the device that performs the sensing service, and the method for changing the device that performs the sensing service, which may be applied to a scenario for integrated sensing and communication.

The wireless sensing apparatus provided in this embodiment of the present disclosure can implement the processes implemented in the method embodiments of FIG. 10 and FIG. 4 to FIG. 7, and a same technical effect can be achieved. To avoid repetition, details are not described herein again.

For example, as shown in FIG. 13, an embodiment of the present disclosure further provides a wireless sensing device 1300. The wireless sensing device may be the first device or the first sensing function network element in the foregoing embodiment, including a processor 1301 and a memory 1302. The memory 1302 stores a program or an instruction that can be run on the processor 1301. For example, in a case that the wireless sensing device 1300 is the first device, when the program or the instruction is executed by the processor 1301, the steps of the embodiment of the wireless sensing method at the first device side are implemented, and a same technical effect can be achieved. When the wireless sensing device 1300 is a first sensing function network element, the program or the instruction is executed by the processor 1301 to implement the steps of the embodiment of the wireless sensing method at the first sensing function network element side, and a same technical effect can be achieved. To avoid repetition, details are not described herein again.

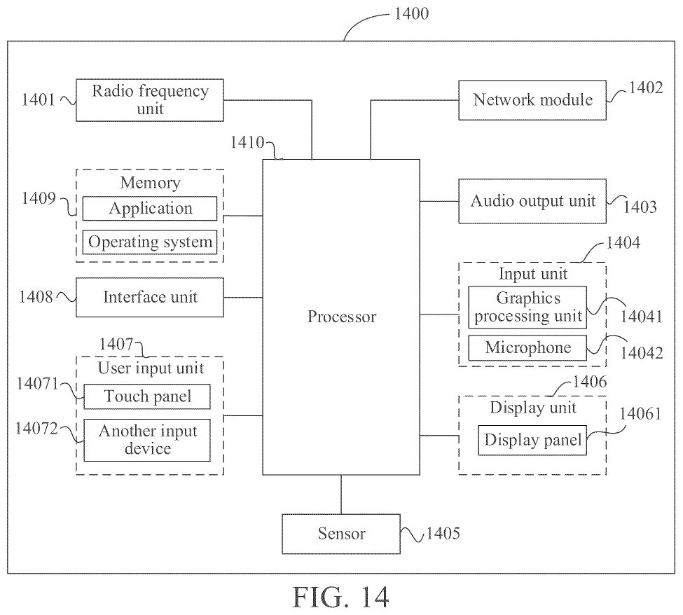

An embodiment of the present disclosure further provides a first device, including a processor and a communication interface, where the processor is configured to determine wireless sensing capability information, the wireless sensing capability information is an information set used to represent whether a sensing service is able to be performed or a performance level that is able to be achieved around the sensing service in a case that the sensing service is able to be performed. This embodiment of the first device is corresponding to the foregoing method embodiment from the first device side. Each implementation process and implementation of the foregoing method embodiment may be applicable to this embodiment of the first device, and a same technical effect can be achieved. FIG. 14 is a schematic diagram of a hardware structure of a first device according to an embodiment of the present disclosure.

The first device 1400 includes but is not limited to at least some of the following components: a radio frequency unit 1401, a network module 1402, an audio output unit 1403, an input unit 1404, a sensor 1405, a display unit 1406, a user input unit 1407, an interface unit 1408, a memory 1409, and a processor 1410.

A person skilled in the art can understand that the first device 1400 may further include a power supply (such as a battery) that supplies power to each component. The power supply may be logically connected to the processor 1410 by using a power supply management system, to implement functions such as charging and discharging management, and power consumption management by using the power supply management system. The terminal structure shown in FIG. 14 constitutes no limitation on the first device, and the first device may include more or fewer components than those shown in the figure, or combine some components, or have different component arrangements. Details are not described herein again.

It should be understood that in this embodiment of the present disclosure, the input unit 1404 may include a graphics processing unit (GPU) 14041 and a microphone 14042. The graphics processing unit 14041 processes image data of a static picture or a video obtained by an image capture apparatus (for example, a camera) in a video capture mode or an image capture mode. The display unit 1406 may include a display panel 14061, and the display panel 14061 may be configured in a form of a liquid crystal display, an organic light-emitting diode, or the like. The user input unit 1407 includes at least one of a touch panel 14071 and another input device 14072. The touch panel 14071 is also referred to as a touchscreen. The touch panel 14071 may include two parts: a touch detection apparatus and a touch controller. The other input device 14072 may include but is not limited to a physical keyboard, a functional button (such as a volume control button or a power on/off button), a trackball, a mouse, and a joystick. Details are not described herein again.

In this embodiment of the present disclosure, after receiving downlink data from a network side device, the radio frequency unit 1401 may transmit the downlink data to the processor 1410 for processing. In addition, the radio frequency unit 1401 may send uplink data to the network side device. Generally, the radio frequency unit 1401 includes but is not limited to an antenna, an amplifier, a transceiver, a coupler, a low noise amplifier, a duplexer, and the like.

The memory 1409 may be configured to store a software program or an instruction and various data. The memory 1409 may mainly include a first storage area for storing a program or an instruction and a second storage area for storing data. The first storage area may store an operating system, and an application or an instruction required by at least one function (for example, a sound playing function or an image playing function). In addition, the memory 1409 may be a volatile memory or a non-volatile memory, or the memory 1409 may include a volatile memory and a non-volatile memory. The non-volatile memory may be a read-only memory (ROM), a programmable read-only memory (Programmable ROM (PROM)), an erasable programmable read-only memory (EPROM), an electrically erasable programmable read-only memory (EEPROM), or a flash memory. The volatile memory may be a random access memory (RAM), a static random access memory (Static RAM (SRAM)), a dynamic random access memory (Dynamic RAM (DRAM)), a synchronous dynamic random access memory (Synchronous DRAM (SDRAM)), a double data rate synchronous dynamic random access memory (Double Data Rate SDRAM (DDRSDRAM)), an enhanced synchronous dynamic random access memory (Enhanced SDRAM (ESDRAM)), a synch link dynamic random access memory (Synch link DRAM (SLDRAM)), and a direct Rambus random access memory (Direct Rambus RAM (DRRAM)). The memory 1409 in this embodiment of the present disclosure includes but is not limited to these memories and any memory of another proper type.

The processor 1410 may include one or more processing units. In some embodiments, an application processor and a modem processor are integrated into the processor 1410. The application processor mainly processes an operating system, a user interface, an application, or the like. The modem processor mainly processes a wireless communication signal, for example, a baseband processor. It can be understood that the foregoing modem processor may not be integrated into the processor 1410.

The processor 1410 is configured to determine wireless sensing capability information, where the wireless sensing capability information is an information set used to represent whether a sensing service is able to be performed or a performance level that is able to be achieved around the sensing service in a case that the sensing service is able to be performed.

In the embodiments of the present disclosure, a definition of the wireless sensing capability information is given, and the first device determines the wireless sensing capability information, which can be applied to a scenario for integrated sensing and communication.

In some embodiments, the radio frequency unit 1401 is configured to report the static capability information of the first device to the first sensing function network element.

In some embodiments, the radio frequency unit 1401 is configured to perform one of the following:
reporting the static capability information of the first device immediately after the first device accesses a first network;
reporting the static capability information of the first device in a case that the first device is in an idle state after accessing the first network; and
reporting the static capability information of the first device in a case that first capability enquiry information sent by the first sensing function network element is received, where the first capability enquiry information is used to instruct the first device to report the static capability information, where
the first network is a network corresponding to the first sensing function network element.

In some embodiments, the radio frequency unit 1401 is configured to perform one of the following:
reporting complete information of the static capability information of the first device to the first sensing function network element;
reporting level information corresponding to the static capability information of the first device to the first sensing function network element;
reporting partial information in the static capability information of the first device to the first sensing function network element;
reporting a device type and/or software version information and/or hardware version information of the first device to the first sensing function network element; and
reporting an identification code of the static capability information of the first device to the first sensing function network element.

In some embodiments, the radio frequency unit 1401 is further configured to:
receive second capability enquiry information sent by the first sensing function network element, where the second capability enquiry information is used to instruct the first device to report the dynamic capability information; and
report the dynamic capability information of the first device to the first sensing function network element.

In some embodiments, the radio frequency unit 1401 is further configured to perform at least one of the following:
reporting, based on indication of the second capability enquiry information, complete information of dynamic capability information of all entries or a designated entry;
reporting, based on indication of the second capability enquiry information, a part of the dynamic capability information of all entries or a designated entry that is different from the static capability information of a corresponding entry; and
reporting, based on indication of the second capability enquiry information, a part of the dynamic capability information of all entries or a designated entry that is different from historically reported dynamic capability information of a corresponding entry.

In some embodiments, the radio frequency unit 1401 is further configured to: receive sensing demand information and first request information sent by the first sensing function network element, where the first request information is used to instruct the first device to feed back whether a first sensing service is able to be performed.

The processor 1410 is further configured to: determine, based on the sensing demand information and the dynamic capability information of the first device, whether the first sensing service is able to be performed; and
the radio frequency unit 1401 is further configured to: send first feedback information to the first sensing function network element, where the first feedback information is used to indicate whether the first device is able to perform the first sensing service.

In some embodiments, the radio frequency unit 1401 is further configured to: receive first sensing start information sent by the first sensing function network element, where the first sensing start information is used to instruct the first device to perform the first sensing service.

In some embodiments, the processor 1410 is further configured to:
perform the first sensing service in a case that the first device receives second sensing start information sent by a second sensing function network element, and a priority of the first sensing service is higher than a priority of a second sensing service indicated by the second sensing start information; or
skip performing the first sensing service, and report a device conflict message to the first sensing function network element in a case that the first device receives second sensing start information sent by a second sensing function network element, and a priority of the first sensing service is lower than or equal to a priority of a second sensing service indicated by the second sensing start information, where the device conflict message is used to instruct the first sensing function network element to reselect a device to perform the first sensing service.

In some embodiments, the processor 1410 is further configured to:
receive the sensing demand information sent by the first sensing function network element, and determine, based on requirement information for capability information of the second device in the sensing demand information, the second device that performs the first sensing service together with the first device;
or
determine, based on requirement information for capability information of the second device in the sensing demand information, the second device that performs the first sensing service together with the first device.

In some embodiments, the determining, based on requirement information for capability information of the second device in the sensing demand information, the second device that performs the first sensing service together with the first device includes:
selecting, based on static capability information of a candidate device and the requirement information for the capability information of the second device in the sensing demand information, one or more candidate second devices from the candidate device, where the candidate second device matches a sensing target location and/or a sensing target area, and the candidate device is a device scheduled by the first sensing function network element other than the first device;
sending the second capability enquiry information to the candidate second device and receiving dynamic capability information fed back by the candidate second device, where the second capability enquiry information is used to instruct the candidate second device to feed back the dynamic capability information; and
receiving the dynamic capability information fed back by the candidate second device, and determining, based on the dynamic capability information fed back by the candidate second device, the second device that performs the first sensing service together with the first device;
or
selecting, based on static capability information of a candidate device and the requirement information for the capability information of the second device in the sensing demand information, one or more candidate second devices from the candidate device, where the candidate second device matches a sensing target location and/or a sensing target area, and the candidate device is a device scheduled by the first sensing function network element other than the first device;
sending the sensing demand information and the first request information to the candidate second device, and receiving the first feedback information sent by the candidate second device, where the first request information is used to instruct the candidate second device to feed back whether the first sensing service is able to be performed, and the first feedback information is used to indicate whether the candidate second device is able to perform the first sensing service; and
determining the second device that performs the first sensing service together with the first device from the candidate second device feeding back that the first sensing service is able to be performed;
or
sending the second capability enquiry information to all candidate second devices having a first communication connection relationship with the first device and matching the sensing target location and/or the sensing target area, where the second capability enquiry information is used to instruct the candidate second device to feed back the dynamic capability information; and
receiving the dynamic capability information fed back by the candidate second device, and determining, by the first device based on the dynamic capability information fed back by the candidate second device and with reference to the requirement information for the capability information of the second device in the sensing demand information, the second device that performs the first sensing service together with the first device;
or
sending the sensing demand information and the first request information to all candidate second devices having a first communication connection relationship with the first device and matching the sensing target location and/or the sensing target area, where the first request information is used to instruct the candidate second device to feed back whether the first sensing service is able to be performed; and
receiving the first feedback information fed back by the candidate second device, and determining, by the first device, the second device that performs the first sensing service together with the first device from the candidate second device feeding back that the first sensing service is able to be performed, where the first feedback information is used to indicate whether the candidate second device is able to perform the first sensing service.

In some embodiments, the radio frequency unit 1401 is further configured to report change information of the dynamic capability information to the first sensing function network element.

In some embodiments, the radio frequency unit 1401 is further configured to perform one of the following:
reporting, by the first device, the change information of the dynamic capability information to the first sensing function network element in a case that the dynamic capability information of the first device is changed;
reporting, by the first device, the change information of the dynamic capability information to the first sensing function network element in a case that a reporting period of the change information of the dynamic capability information of the first device arrives; and
reporting, by the first device, the change information of the dynamic capability information to the first sensing function network element in a case that the first device receives third capability enquiry information sent by the first sensing function network element, where the third capability enquiry information is used to instruct the first device to report the change information of the dynamic capability information.

In this embodiment of the present disclosure, the definition for the wireless sensing capability information is given, as well as the method and process for the sensing function network element and the device to select, by using the wireless sensing capability information of the device, the device that performs the sensing service, and the method for changing the device that performs the sensing service, which may be applied to a scenario for integrated sensing and communication.

An embodiment of the present disclosure further provides a sensing function network element, including a processor and a communication interface, where the processor is configured to determine, based on wireless sensing capability information and sensing demand information, a target device to perform a first sensing service, where the wireless sensing capability information is from one or more devices scheduled by a first sensing function network element; and the sensing demand information includes description of capability information required to perform the first sensing service. The sensing function network element embodiment is corresponding to the wireless sensing method embodiment at the sensing function network element side, each implementation process and implementation of the method embodiment can be applied to the sensing function network element embodiment, and a same technical effect can be achieved.

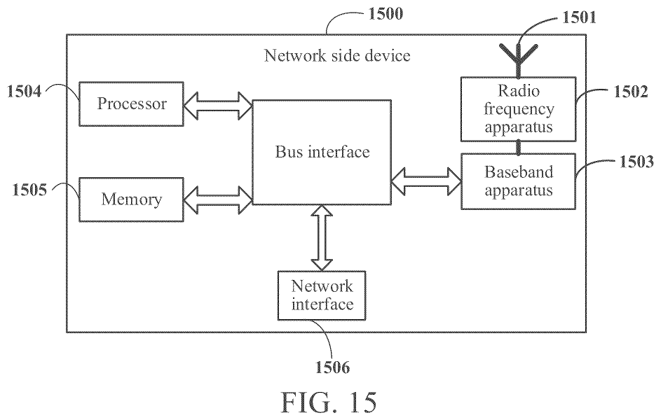

An embodiment of the present disclosure further provides a sensing function network element. As shown in FIG. 15, the sensing function network element 1500 includes: an antenna 1501, a radio frequency apparatus 1502, a baseband apparatus 1503, a processor 1504, and a memory 1505. The antenna 1501 is connected to the radio frequency apparatus 1502. In an uplink direction, the radio frequency apparatus 1502 receives information by using the antenna 1501, and sends the received information to the baseband apparatus 1503 for processing. In a downlink direction, the baseband apparatus 1503 processes to-be-sent information, and sends the to-be-sent information to the radio frequency apparatus 1502. After processing the received information, the radio frequency apparatus 1502 sends the information through the antenna 1501.

In the foregoing embodiment, a method performed by the sensing function network element may be implemented in the baseband apparatus 1503. The baseband apparatus 1503 includes a baseband processor.

The baseband apparatus 1503 may include, for example, at least one baseband board. A plurality of chips are disposed on the baseband board. As shown in FIG. 15, one chip is, for example, the baseband processor, connected to the memory 1505 through a bus interface, to invoke a program in the memory 1505, thereby performing operations of the sensing function network element shown in the foregoing method embodiment.

The sensing function network element may further include a network interface 1506. The interface is, for example, a common public radio interface (CPRI).

The sensing function network element 1500 in this embodiment of the present disclosure further includes an instruction or a program stored in the memory 1505 and runnable on the processor 1504. The processor 1504 invokes the instruction or the program in the memory 1505 to perform the method performed by the modules shown in FIG. 12, and a same technical effect is achieved. To avoid repetition, details are not described herein again.

An embodiment of the present disclosure further provides a readable storage medium. The readable storage medium stores a program or an instruction, and when the program or the instruction is executed by a processor, the processes of the foregoing wireless sensing method embodiment are implemented, and a same technical effect can be achieved. To avoid repetition, details are not described herein again.

The processor is a processor in the terminal in the foregoing embodiments. The readable storage medium includes a computer-readable storage medium, such as a computer read-only memory (ROM), a random access memory (RAM), a magnetic disk, or an optical disc.

An embodiment of the present disclosure also provides a chip. The chip includes a processor and a communication interface, and the communication interface is coupled to the processor. The processor is configured to run a program or an instruction to implement the processes of the foregoing wireless sensing method embodiment, and a same technical effect can be achieved. To avoid repetition, details are not described herein again.

It should be understood that the chip mentioned in this embodiment of the present disclosure may also be referred to as a system-level chip, a system chip, a chip system, or a system on chip.

An embodiment of the present disclosure also provides a computer program/program product. The computer program/program product is stored in a storage medium, and the computer program/program product is executed by at least one processor to implement the processes of the wireless sensing method embodiment, and a same technical effect can be achieved. To avoid repetition, details are not described herein again.

An embodiment of the present disclosure further provides a wireless sensing system, including: a first device and a first sensing function network element, where the first device can be used to perform the steps of the wireless sensing method, and the first sensing function network element can be used to perform the steps of the wireless sensing method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to such process, method, article, or apparatus. In absence of more constraints, an element preceded by a statement “includes a . . . ” does not preclude the presence of additional identical elements in the process, method, article, or apparatus that includes the element. In addition, it should be noted that the scope of the methods and apparatuses in the embodiments of the present disclosure is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In some embodiments, the technical solutions of the present disclosure entirely or the part contributing to the prior art may be implemented in a form of a computer software product. The computer software product is stored in a storage medium (such as a ROM/RAM, a hard disk, or an optical disc), and includes several instructions for instructing a terminal (which may be a mobile phone, a computer, a server, an air-conditioner, a network device, or the like) to perform the method described in the embodiments of the present disclosure.

The embodiments of the present disclosure are described above with reference to the accompanying drawings, but the present disclosure is not limited to the foregoing implementations, and the foregoing implementations are only illustrative and not restrictive. Under the enlightenment of the present disclosure, a person of ordinary skill in the art can make many forms without departing from the purpose of the present disclosure and the protection scope of the claims, all of which fall within the protection of the present disclosure.

What is claimed is:

1. A wireless sensing method, comprising:
determining, by a first device, wireless sensing capability information, wherein the wireless sensing capability information is an information set used to represent whether a sensing service is able to be performed or a performance level that is able to be achieved around the sensing service when the sensing service is able to be performed.

2. The wireless sensing method according to claim 1, wherein the wireless sensing capability information comprises at least one of the following: a first capability set or a second capability set, wherein
the first capability set is a sensing-enhanced capability set existing in communication; and
the second capability set is a sensing-specific capability set,
wherein:
the first capability set comprises at least one of the following:
a frequency-related capability;
a power-related capability; or
a beam-related capability;
or
the second capability set comprises at least one of the following:
a capability for sensing a radio frequency;
a supported sensing service type;
a supported sensing signal waveform;
a supported sensing measurement quantity;
a supported sensing indicator;
a supported control or scheduling capability related to sensing; or
a capability of assistance information related to sensing.

3. The wireless sensing method according to claim 2,
wherein:
the frequency-related capability comprises at least one of the following:
a band or a band combination supporting a sensing function and a bandwidth of each band or band combination;
a receive/transmit capability of a sensing signal supported by each band or band combination; or
a quantity of independent radio frequency channels or a quantity of antennas or an antenna layout for receiving/transmitting the sensing signal supported by each band or band combination,
or
the power-related capability comprises at least one of the following:
a supported power level of the sensing signal, or a maximum peak power of the sensing signal, or a maximum average power of the sensing signal;
a supported maximum transmission time ratio of the sensing signal, or a maximum transmission power of the sensing signal for a given transmission time ratio;
whether to support power adaptive adjustment of the sensing signal, or a power control parameter; or
whether to support a maximum power back-off mechanism, or a supported maximum power back-off value,
or
the beam-related capability comprises at least one of the following:
whether to support sensing signal transmitting beam scanning or receiving beam scanning;
whether to support sensing signal transmitting beam selection or receiving beam selection;
whether to support sensing signal transmitting beam adaptation or receiving beam adaptation;
whether to support sensing signal transmitting beamforming or receiving beamforming; or
whether to support sensing signal beam measurement and a beam report.

4. The wireless sensing method according to claim 2,
wherein:
the capability for sensing a radio frequency comprises at least one of the following:
whether to support bandwidth splicing of the sensing signal and corresponding signal processing;
whether to support simultaneous transmission of multiple beams, wherein the multiple beams comprise at least one of the following: a communication beam, a sensing beam, or a communication sensing beam;
a switching speed of the sensing beam; or
whether to support frequency hopping of the sensing signal,
or
the supported sensing signal waveform comprises at least one of the following:
supporting transmission or reception, or transmission and reception through time division, or simultaneous transmission and reception of a communication dominant signal;
supporting transmission or reception, or transmission and reception through time division, or simultaneous transmission and reception of a sensing dominant signal;
supporting transmission or reception, or transmission and reception through time division, or simultaneous transmission and reception of a sensing-enhanced communication dominant signal; or
supporting transmission or reception, or transmission and reception through time division, or simultaneous transmission and reception of a signal for integrated sensing and communication,
or
the supported sensing indicator comprises at least one of the following:
a sensing coverage;
a sensing resolution;
sensing accuracy;
a sensing delay-related capability;
a sensing update rate;
a detection probability; or
a false alarm probability.

5. The wireless sensing method according to claim 3,
wherein:
the sensing service type comprises at least one of the following:
a radar detection service;
a user positioning and tracking service;
a three-dimensional reconstruction service;
a weather or air quality detection service;
a pedestrian or vehicle flow detection service;
a health monitoring service;
an action recognition service; or
sensing signal transmission or reception based on radio frequency identification (RFID) or backscatter,
or
the supported control or scheduling capability related to sensing comprises at least one of the following:
whether to support simultaneously scheduling of communication and sensing control information;
a quantity of services supported simultaneously or through time division in a time unit;
whether to support indicating or reporting at least one of a sensing service type, a sensing signal waveform, or a sensing measurement quantity by using physical layer signaling; or
a physical layer buffer size for temporary storage of sensing data, wherein the sensing data comprises at least one of the following: configuration information used for sensing or a sensing measurement quantity,
or
the capability of assistance information related to sensing comprises at least one of the following:
mobility of a device; or
a capability and accuracy for obtaining a location, a posture, or motion information of the device.

6. The wireless sensing method according to claim 3, wherein the supported sensing measurement quantity comprises at least one of the following:
original channel information, wherein the original channel information comprises at least one of the following: a channel matrix or compressed quantization information of the channel matrix, channel state information, or I-channel and Q-channel signal features of a frequency domain channel response;
signal strength information, wherein the signal strength information comprises at least one of the following: reference signal received power (RSRP) or received signal strength index (RSSI);
spectrum information, wherein the spectrum information comprises at least one of following: a channel power delay profile, a Doppler power spectrum, a power angle spectrum, pseudo-spectral information, a delay-Doppler two-dimensional spectrum, or a delay-Doppler-angle three-dimensional spectrum;
multipath information, wherein the multipath information comprises at least one of following: a power, a phase, a delay, or angle information of each path in a multipath channel;
angle information, wherein the angle information comprises at least one of following: an angle of arrival or an angle of departure;
difference information of signals corresponding to different antennas, wherein the difference information of signals corresponding to different antennas comprises at least one of the following: quotient or conjugate multiplication of frequency domain channel responses of a first antenna and a second antenna, an amplitude ratio or an amplitude difference between received signals of the first antenna and the second antenna, a phase difference between signals of the first antenna and the second antenna, or a delay difference between signals of the first antenna and the second antenna;
target parameter information determined based on the original channel information, wherein the target parameter information comprises at least one of the following: Doppler spread, Doppler frequency shift, maximum delay spread, angle spread, a coherence bandwidth, or a coherence time;
radar point cloud information; or
a measurement quantity obtained by performing calculation based on at least two items of the original channel information, the signal strength information, the spectrum information, the multipath information, the angle information, the difference information of signals corresponding to different antennas, the target parameter information, or the radar point cloud information.

7. The wireless sensing method according to claim 1, wherein a granularity of the wireless sensing capability information comprises at least one of the following: per band/band combination, per service/service category, or per device.

8. The wireless sensing method according to claim 1, wherein
the wireless sensing capability information comprises at least one of the following:
static capability information, wherein the static capability information is information for representing an inherent capability of the device determined by a software or hardware configuration of the device; or
dynamic capability information, wherein the dynamic capability information is information for representing an available capability of sensing service.

9. The wireless sensing method according to claim 8, further comprising:
reporting, by the first device, the static capability information of the first device to a first sensing function network element, wherein
the reporting, by the first device, the static capability information of the first device to a first sensing function network element comprises one of the following:
reporting the static capability information of the first device immediately after the first device accesses a first network;
reporting the static capability information of the first device in a case that the first device is in an idle state after accessing the first network;
reporting the static capability information of the first device when first capability enquiry information sent by the first sensing function network element is received, wherein the first capability enquiry information is used to instruct the first device to report the static capability information, wherein the first network is a network corresponding to the first sensing function network element,
wherein the reporting, by the first device, the static capability information of the first device to a first sensing function network element comprises one of the following:
reporting, by the first device, complete information of the static capability information of the first device to the first sensing function network element;
reporting, by the first device, level information corresponding to the static capability information of the first device to the first sensing function network element;
reporting, by the first device, partial information in the static capability information of the first device to the first sensing function network element;
reporting, by the first device, a device type or software version information and/or hardware version information of the first device to the first sensing function network element; or
reporting, by the first device, an identification code of the static capability information of the first device to the first sensing function network element.

10. The wireless sensing method according to claim 8, further comprising:
receiving, by the first device, second capability enquiry information sent by the first sensing function network element, wherein the second capability enquiry information is used to instruct the first device to report the dynamic capability information; and
reporting, by the first device, the dynamic capability information of the first device to the first sensing function network element, wherein the reporting, by the first device, the dynamic capability information of the first device to the first sensing function network element comprises at least one of the following:
reporting, by the first device based on indication of the second capability enquiry information, complete information of dynamic capability information of all entries or a designated entry;
reporting, by the first device based on indication of the second capability enquiry information, a part of the dynamic capability information of all entries or a designated entry that is different from the static capability information of a corresponding entry; or
reporting, by the first device based on indication of the second capability enquiry information, a part of the dynamic capability information of all entries or a designated entry that is different from historically reported dynamic capability information of a corresponding entry.

11. The wireless sensing method according to claim 8, further comprising:
reporting, by the first device, change information of the dynamic capability information to the first sensing function network element,
wherein the reporting, by the first device, change information of the dynamic capability information to the first sensing function network element comprises one of the following:
reporting, by the first device, the change information of the dynamic capability information to the first sensing function network element when the dynamic capability information of the first device is changed;
reporting, by the first device, the change information of the dynamic capability information to the first sensing function network element when a reporting period of the change information of the dynamic capability information of the first device arrives; or
reporting, by the first device, the change information of the dynamic capability information to the first sensing function network element when the first device receives third capability enquiry information sent by the first sensing function network element, wherein the third capability enquiry information is used to instruct the first device to report the change information of the dynamic capability information,
wherein the change information of the dynamic capability information comprises at least one of the following:
dynamic capability information of all entries;
dynamic capability information of a changed entry;
dynamic capability information of a designated entry;
a part of dynamic capability information of all entries or a designated entry different from static capability information or historically reported dynamic capability information;
or
whether dynamic capability information of a device currently performing the first sensing service is able to meet the sensing demand information.

12. A wireless sensing method, comprising:
determining, by a first sensing function network element based on wireless sensing capability information and sensing demand information, a target device to perform a first sensing service, wherein:
the wireless sensing capability information is from one or more devices scheduled by a first sensing function network element; and
the sensing demand information comprises description of capability information required to perform the first sensing service.

13. The wireless sensing method according to claim 12, wherein the determining, by a first sensing function network element based on wireless sensing capability information and sensing demand information, a target device to perform a first sensing service comprises at least one of the following:
determining, by the first sensing function network element based on static capability information and location information of all devices scheduled by the first sensing function network element, and the sensing demand information, a candidate device that possibly has a capability to perform the first sensing service;
sending, by the first sensing function network element, second capability enquiry information to the candidate device, wherein the second capability enquiry information is used to instruct the candidate device to feed back dynamic capability information; or
receiving, by the first sensing function network element, the dynamic capability information sent by the candidate device, and determining, based on the received dynamic capability information, the target device to perform the first sensing service.

14. The wireless sensing method according to claim 12, wherein the determining, by a first sensing function network element based on wireless sensing capability information and sensing demand information, a target device to perform a first sensing service comprises at least one of the following:
determining, by the first sensing function network element based on location information of all devices scheduled by the first sensing function network element and the sensing demand information, a candidate device that performs the first sensing service;
sending, by the first sensing function network element, second capability enquiry information to the candidate device, wherein the second capability enquiry information is used to instruct the candidate device to report dynamic capability information; or
receiving, by the first sensing function network element, the dynamic capability information sent by the candidate device, and determining, by the first sensing function network element based on the received dynamic capability information, the target device to perform the first sensing service from the candidate device.

15. The wireless sensing method according to claim 13, wherein before the determining, by the first sensing function network element based on static capability information and location information of all devices scheduled by the first sensing function network element, and the sensing demand information, a candidate device that possibly has a capability to perform the first sensing service, the method further comprises:
obtaining static capability information of all devices scheduled by the first sensing function network element; and
storing the static capability information to the first sensing function network element or a network node accessible to the first sensing function network element,
wherein the obtaining static capability information of all the devices scheduled by the first sensing function network element comprises at least one of the following:
receiving complete information or partial information of static capability information reported by the device scheduled by the first sensing function network element;
receiving level information reported by the device scheduled by the first sensing function network element, and obtaining the static capability information based on the level information;
receiving a device type or software version information or hardware version information reported by the device scheduled by the first sensing function network element, and obtaining the static capability information based on the device type or the software version information or the hardware version information; or
receiving an identification code of the static capability information reported by the device scheduled by the first sensing function network element, and obtaining the static capability information based on the identification code of the static capability information.

16. The wireless sensing method according to claim 13, wherein the received dynamic capability information comprises at least one of the following:
receiving complete information of dynamic capability information of all entries or a designated entry reported by the candidate device based on indication of the second capability enquiry information;
receiving a part of the dynamic capability information of all entries or a designated entry that is different from the static capability information of a corresponding entry reported by the candidate device based on indication of the second capability enquiry information; or
receiving a part of the dynamic capability information of all entries or a designated entry that is different from historically reported dynamic capability information of a corresponding entry reported by the candidate device based on indication of the second capability enquiry information.

17. The wireless sensing method according to claim 12, further comprising:
receiving, by the first sensing function network element, change information of the dynamic capability information;
determining, by the first sensing function network element based on the change information of the dynamic capability information and the sensing demand information, whether to perform device reselection; and
when it is determined to perform device reselection, reselecting, by the first sensing function network element, a device to perform the first sensing service,
wherein the change information of the dynamic capability information comprises one of the following:
dynamic capability information of all entries;
dynamic capability information of a changed entry;
dynamic capability information of a designated entry;
a part of dynamic capability information of all entries or a designated entry different from static capability information or historically reported dynamic capability information; or
whether dynamic capability information of a device currently performing the first sensing service is able to meet the sensing demand information.

18. The wireless sensing method according to claim 17, wherein the determining, by the first sensing function network element based on the change information of the dynamic capability information and the sensing demand information, whether to perform device reselection comprises:
determining to perform device reselection when the device reporting the change information of the dynamic capability information is a device currently performing the first sensing service, and a first condition is met,
wherein the first condition comprises one of the following:
the change information of the dynamic capability information is the dynamic capability information of all the entries, the dynamic capability information of the changed entry, the dynamic capability information of the designated entry, or the part of dynamic capability information of all entries or a designated entry different from static capability information or historically reported dynamic capability information; the first sensing function network element obtains, based on the change information of the dynamic capability information, changed dynamic capability information of the device currently performing the first sensing service, and the changed dynamic capability information is not able to meet the sensing demand information; or a deviation between the changed dynamic capability information and capability information required by the sensing demand information exceeds a first preset threshold; or
the change information of the dynamic capability information indicates that the dynamic capability information of the device currently performing the first sensing service is not able to meet the sensing demand information.

19. The wireless sensing method according to claim 13, further comprising:
selecting, by the first sensing function network element, at least one standby device, and sending third capability enquiry information to the at least one standby device, wherein the third capability enquiry information is used to instruct the standby device to report change information of the dynamic capability information, wherein
the standby device is a device, determined by the first sensing function net work element in a process of determining the target device, for which a deviation between static capability information or dynamic capability information and capability information required by the sensing demand information is less than a first preset threshold, and a deviation between the location information and the sensing target location or the sensing target area is less than a second preset threshold.

20. A wireless sensing device, comprising a processor; and a memory having a computer program or an instruction stored thereon, wherein the computer program or the instruction, when executed by the processor, causes the processor to implement operations, comprising:
determining wireless sensing capability information, wherein the wireless sensing capability information is an information set used to represent whether a sensing service is able to be performed or a performance level that is able to be achieved around the sensing service when the sensing service is able to be performed.
